(19) United States
(12) Patent Application Publication
(10) Pub. No.: US 2014/0043195 A1
(43) Pub. Date: Feb. 13, 2014

(54) DEVICE AND METHOD FOR CONTROLLING AZIMUTH BEAMWIDTH ACROSS A WIDE FREQUENCY RANGE

(71) Applicant: Jaybeam UK, Wellingborough (GB)

(72) Inventors: Jimmy HO, Wellingborough (GB); Simon Christopher R. MUNDAY, Corby (GB); Charanjit SAILOPAL, Hitchin (GB); David Harold BOARDMAN, Ipswich (GB); Barry John TALBOT, Rugby (GB); Michal KLINKOSZ, Wellingborough (GB)

(21) Appl. No.: 13/967,110

(22) Filed: Aug. 14, 2013

Related U.S. Application Data
(63) Continuation-in-part of application No. 12/869,429, filed on Aug. 26, 2010.

(51) Int. Cl. H01Q 13/10

(52) U.S. Cl. CPC H01Q 13/10
USPC 343/770

(57) ABSTRACT

A system and method for controlling azimuth beamwidth in a wide band antenna array, the system including radiating element(s) disposed above a ground plane and parasitic element(s). The parasitic element(s) include a slot formed therein, the parasitic element(s) and slot(s) configured to control beamwidth across a specific frequency range. The parasitic element(s) and the slot(s) may be configured to control beamwidth across contiguous or non-contiguous frequency ranges.

### CROSS-REFERENCE TO RELATED APPLICATIONS

This application claims the benefit of U.S. Provisional Application Ser. No. 61/237,060, filed Aug. 26, 2009, and U.S. application Ser. No. 12/869,429, filed Aug. 26, 2010, the entire disclosures of which are hereby incorporated by reference.

### BACKGROUND

1. Inventive Field

Exemplary embodiments relate to devices and methods for controlling azimuth beamwidth of an antenna or antenna array across a wide frequency range. In particular, exemplary embodiments relate to parasitic elements that minimize the variation of the azimuth beamwidth of an antenna across a broad frequency range, especially when used in base station applications.

2. Description of the Related Art

Wireless communication networks, such as cellular phone networks, provide broadband, digital voice, messaging, and data services to mobile communication devices, such as cellular phones. Those wireless networks use the Ultra High Frequency (UHF) portion of the radio frequency spectrum to transmit and receive signals. The UHF portion of the radio frequency spectrum designates a range of electromagnetic waves with frequencies between 300 MHz and 3000 MHz. Different wireless communication networks operate within different bands of frequency within that range. For historical reasons, the frequencies used for wireless communication networks tend to differ in the Americas, Europe, and Asia. Thus, there is a wide array of different frequency bands over which wireless communication networks operate.

The frequency bands over which wireless communication networks operate include, but are not limited to, the following:

| | | | Frequencies |
|---|---|---|---|
| Band | Common Name | Region | (MHz) |
| 700 | Seven Hundred Megahertz (SMH) | United | Tx: 698-715 & |
| | | States | 777-798 |
| | | | Rx: 728-756 & |
| | | | 758-768 |
| 800 | Digital Dividend (DD) | Europe | Tx: 791-821 |
| | | | Rx: 832-862 |
| 850 | Evolution-Data Optimized (EV-DO) | Americas | Tx: 824-849 |
| | | | Rx: 869-894 |
| 900 | Primary Global System for Mobile | Europe | Tx: 880-915 |
| | Communications (GSM-900) | | Rx: 925-960 |
| 1700 | Advanced Wireless Services (AWS) | North | Tx: 1710-1755 |
| | | America | Rx: 2110-2170 |
| 1800 | Digital Cellular System (DCS) | Europe & | Tx: 1710-1785 |
| | | Asia | Rx: 1805-1880 |
| 1900 | Personal Communications Service | Americas | Tx: 1850-1910 |
| | (PCS) | | Rx: 1930-1990 |
| 2000 | Universal Mobile Telecom System | Europe | 1900-1920 & |
| | with Time Division Duplexing | | 2010-2025 |
| | (UMTS-TDD) | | |
| 2600 | International Mobile Telecommu- | Europe | Tx: 2500-2570 |
| | nication Extension (IMT-E) | | Rx: 2620-2690 |

As that list demonstrates, much of the UHF portion of the radio frequency spectrum is occupied by different wireless communication networks, especially with the onset of networks being developed under the Long Term Evolution (LTE) standard at the lower and upper ends of the spectrum (e.g., SMH, DD, and IMT-E networks).

The rapid development of new wireless communication networks has created the need for a variety of base station antenna configurations with a broad range of technical requirements. One of those technical requirements is frequently that the antenna operates across more than one mobile radio frequency band. The main beam of such an antenna is generally fan shaped—narrow in the elevation plane and wide in the azimuth plane. The beam is wide in the azimuth plane to serve the required coverage sector and is compressed in the elevation plane to achieve high gain. But as the bandwidth of the antenna increases, physics dictates that the range of values of the azimuth beamwidth will also increase, which results in a large variation in coverage area as a function of frequency. Thus, antennas that operate across a wide frequency range typically suffer from variation of azimuth beamwidth across their full frequency range.

Base station antennas often include vertical linear arrays of microstrip patch radiators. Microstrip patch radiators include a conductive plate separated from a ground plane by a dielectric medium. For base station applications, patch radiators are commonly oriented with their edges at an angle of 45° to the vertical with feed points on two adjacent edges to provide dual slant-polar radiation. In an effort to maintain the desired beamwidth in such antennas, it has been discovered that both azimuth beamwidth and the variation of beamwidth as a function of frequency (beamwidth dispersion) may be controlled by the use of parasitic strips disposed in the same plane as the patch radiator. Similar results have also been achieved by forming slots into the ground plane below the plane of the patch radiator (see, e.g., U.S. Pat. No. 6,320,544 to Korisch et al.). Slots may also be formed in upturned edges of the groundplane as disclosed by Gabriel (U.S. Pat. No. 6,195,063).

Base station antennas may also include vertical linear arrays of crossed dipole radiators. As FIG. 1A illustrates, a crossed dipole radiator 102 includes a pair of dipoles 102A and 102B disposed substantially orthogonally with respect to each other, with their center points co-located so as to form the shape of an “X” or a cross. The crossed dipole radiator 102 is located in front of a planar conductive ground plane 104. The pair of dipoles 102A and 102B is positioned at a 45° angle with respect to the vertical edges of the ground plane so as to form what is generally known as a cross-polar, or dual slant-polar, configuration 100. Like patch radiators, crossed dipole radiators 102 and their corresponding ground planes 104 may be arranged in vertical linear arrays with the longitudinal edge of their corresponding ground planes 104 extending vertically and the lateral edge of their corresponding ground planes 104 extending parallel with the plane of the crossed dipole 102.

FIG. 1B illustrates the 3-dB azimuth beamwidth of the slant-polar configuration 100 of FIG. 1A. The azimuth beamwidth is measured over a frequency range of 1700-3000 MHz. The azimuth beamwidth varies from 79° to 123° across that frequency range, illustrating a corresponding beamwidth dispersion (variation) of 44° (123°−79°=44°). In addition, the beamwidth values increase dramatically at the higher end of that frequency range. In the 1700-2200 MHz frequency range, the beamwidth is relatively constant, with a dispersion of only 3° (82°−79°=3°). Accordingly, the slant-polarized configuration 100 of FIG. 1A is particularly suited to the deployment of networks that operate within the 1700-2200 MHz frequency range (e.g., AWS, DCS, and PCS networks). As FIG. 1B illustrates, however, it is not suited for deploying networks in the higher frequency bands (e.g., IMT-E).

According to the related art, parasitic strips may be utilized as subsidiary radiators to control azimuth beamwidth and beamwidth dispersion for antennas that include microstrip patch radiators or crossed dipole radiators. FIG. 2A illustrates a crossed-dipole array 200 that includes parasitic strips 202 laterally disposed on opposing sides of the crossed dipole radiator 102. The crossed dipole radiator 102 is typically positioned a quarter wavelength from the reflector at the mid-band frequency. The parasitic strips 202 are disposed at a distance in front of the ground plane 104 which, together with their chosen length, provides the most constant azimuth beamwidth across the desired operating frequency band.

In operation, the parasitic strips 202 of the array 200 are excited parasitically by the crossed dipole radiator 102 so that together the combination of elements forms an electromagnetically coupled resonant circuit that both reduces the average value of the azimuth beamwidth and also reduces the variation of beamwidth with frequency. For example, as illustrated by a comparison of FIG. 2B with FIG. 1B, the parasitic strips 202 reduce the beamwidth at almost every frequency across the 1700-3000 MHz frequency range (e.g., from 79° to 66° at 1700 MHz and from 123° to 81° at 3000 MHz) and reduce beamwidth dispersion from 44° (123°−79°=44°) to 15° (81°−66°=15°).

In lieu of using parasitic strips, similar improvements may be obtained according to the related art by using a conductive parasitic enclosure to form an electromagnetically coupled resonant structure. As FIG. 3A illustrates, the resulting configuration 300 includes a conductive box structure 302 disposed around the crossed dipole radiator 102. The distance between the radiator 102 and the reflector 104 is typically approximately a quarter wavelength at the center frequency of the operating frequency range. The box structure 302 includes four sides 304 that are substantially parallel with the vertical and horizontal edges of the ground plane 104 and that extend perpendicularly from the ground plane 104 in the direction of the z-axis. The purpose of the box structure is to provide a symmetrical environment for the radiating element 102 and to reduce the electromagnetic coupling between adjacent pairs of crossed dipoles. As FIG. 3B illustrates, the box structure 302 also reduces the average value of the azimuth beamwidth and causes the azimuth beamwidth to be more constant across the operating frequency range. As illustrated by a comparison of FIG. 3B with FIG. 1B, the box structure 302 reduces the beamwidth at almost every frequency across the range (e.g., from 80° to 78° at 1960 MHz and from 123° to 49° at 3000 MHz) and that the beamwidth dispersion is reduced from 44° (123°−79°=44°) to 29° (78°−49°=29°).

Despite the reduced beamwidth dispersion illustrated in FIGS. 2B and 3B, neither the parasitic strips 202 nor the box structure 302 adequately controls azimuth beamwidth and beamwidth dispersion across the entire 1700-3000 MHz frequency range. For example, severe beamwidth variations still appear toward the extreme ends of that frequency range and the total beamwidth dispersion observed across that frequency range (i.e., 15 degrees and 29 degrees) is still significantly larger than is acceptable for network planning, as observed in the 1700-2200 MHz band (i.e., 3 degrees). Moreover, neither the parasitic strips 202 nor the box structure 302 allow the azimuth beamwidth and beamwidth dispersion to be controlled in non-contiguous frequency ranges (e.g., the 695-960 MHz band and the 1710-2170 MHz band).

These shortcomings of the related art are particularly troublesome in view of the burgeoning wireless communication networks being developed under the LTE standard. Networks being developed under the LTE standard utilize frequencies as low as 698 MHz (e.g., the SMH network) and as high as 2690 MHz (e.g., the IMT-E network). Accordingly, there is a need for a device and/or method for controlling azimuth beamwidth across a wider frequency range than is provided for by the related art.

FIGS. 1A, 2A, 3A, 4, 5A, 6-8A, 10A, 12, 14A, and 15 are illustrated relative to an X-axis, a Y-axis, and a Z-axis where the ground plane 104 is substantially parallel to the X-Y axis. As one of ordinary skill in the art would recognize, exemplary embodiments of the present invention may be rotated in any direction. For example, as illustrated in FIG. 14A, the ground plane 104 may be disposed vertically (i.e., substantially parallel to the direction of gravity).

### SUMMARY

In order to address these and other deficiencies of the related art, a system and method for maintaining a near-constant azimuth beamwidth in an antenna operating over a single extended frequency range or over two extended non-contiguous frequency ranges is provided. The system includes one or more radiating elements disposed above a ground plane and one or more elongate conductive parasitic elements disposed proximate to and/or around the radiating element(s). Each of the elongate conductive parasitic elements has a slot formed therein. Both the length of the elongate conductive parasitic element and the slot formed therein are configured to have their maximum effectiveness at chosen frequencies in the operating frequency range of the radiating elements. At these frequencies, the parasitic arrangement of the combined elongate conductive members and the slots formed therein exhibit electromagnetic resonances. The frequencies of the resonance of the elongate conductive member and the slot configured therein may be chosen to provide operation over a single extended frequency range (for example, a “wideband antenna” which operates over the 1710-2690 MHz frequency range).

In a further embodiment, a second elongate conductive parasitic element is disposed within the slots in the first parasitic to control beamwidth across a second frequency range which may be non-contiguous with the first frequency range. For example, the first conductive parasitic element and the slot therein may be chosen to optimise the azimuth beamwidth in the 698-960 MHz frequency range, while the second conductive parasitic element, disposed within the slot in the first parasitic element and having a second slot therein, may be configured to control beamwidth in the 1710-2700 MHz frequency range. Such an antenna array, operating in non-contiguous frequency ranges, is referred to herein as a dual-band array. Accordingly, exemplary embodiments provide an arrangement and method for providing an azimuth beam having more constant beamwidth across a much wider frequency range than related art parasitic strips and enclosures. Those and other objects, advantages, and features of exemplary embodiments will become more readily apparent when reference is made to the following description, taken in conjunction with the accompanying claims and drawings.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments. In the drawings like reference numerals designate corresponding parts throughout the several views.

FIG. 1A is an isometric view illustrating a slant-polar crossed-dipole antenna configuration according to the related art;

FIG. 1B is a chart illustrating the 3-dB beamwidth generated by the slant-polar configuration of FIG. 1A across a frequency range of 1700-3000 MHz;

FIG. 2A is an isometric view illustrating a crossed-dipole array operating over a single frequency range according to the related art;

FIG. 2B is a chart illustrating the 3-dB beamwidth generated by the array of FIG. 2A across a frequency range of 1700-3000 MHz;

FIG. 3A is an isometric view illustrating a boxed antenna configuration according to the related art;

FIG. 3B is a chart illustrating the 3-dB beamwidth generated by the boxed antenna configuration of FIG. 3A across a frequency range of 1700-3000 MHz;

FIG. 4 is an isometric view illustrating a slotted parasitic strip according to exemplary embodiments;

FIG. 5A is an isometric view illustrating an antenna configuration that utilizes the slotted parasitic strip of FIG. 4;

FIG. 5B is a chart illustrating the 3-dB beamwidth generated by the array of FIG. 5A across a frequency range of 1700-3000 MHz using a first conductive parasite length and slot length;

FIG. 5C is a chart illustrating the 3-dB beamwidth generated by the array of FIG. 5A across a frequency range of 1700-3000 MHz using a second slot length;

FIG. 6 is an isometric view illustrating a dual-band array that utilizes the slotted parasitic strip of FIG.;

FIG. 7 is an isometric view illustrating a dual-band array that utilizes the slotted parasitic strip of FIG. 4 according to exemplary embodiments;

FIG. 8A is an isometric view illustrating a boxed configuration that utilizes a modified box structure according to exemplary embodiments;

FIG. 8B is a chart illustrating the 3-dB beamwidth generated by the boxed configuration of FIG. 8A across a frequency range of 1700-3000 MHz;

FIG. 9 is a view illustrating an angled slot according to exemplary embodiments;

FIG. 10A is an isometric view illustrating a boxed configuration that utilizes a modified box structure that incorporates the angled slot of FIG. 9;

FIG. 10B is a chart illustrating the 3-dB beamwidth generated by the boxed configuration of FIG. 10A across a frequency range of 1700-3000 MHz;

FIG. 10C is a chart illustrating the radiation pattern generated by the boxed configuration of FIG. 10A at a frequency of 1700 MHz;

FIG. 10D is a chart illustrating the radiation pattern generated by the boxed configuration of FIG. 10A at a frequency of 2200 MHz;

FIG. 11 is a view illustrating the angled slot of FIG. 9 with a parasitic strip disposed therein;

FIG. 12 is an isometric view illustrating a boxed configuration that utilizes a modified box structure that incorporates the angled slot and parasitic strip of FIG. 11;

FIGS. 13A-13D are views illustrating a printed circuit board according to an exemplary embodiment;

FIG. 14A is an isometric view illustrating a boxed configuration that utilizes two of the printed circuit boards of FIG. 13 according to an exemplary embodiment;

FIG. 14B is a chart illustrating the radiation pattern generated by the boxed configuration of FIG. 14A across a frequency range of 1700-2200 MHz according to an exemplary embodiment;

FIG. 15A illustrates an antenna array comprising radiating elements for two frequency bands according to an exemplary embodiment;

FIG. 15B is a chart illustrating the 3-dB beamwidth generated by the antenna array of FIG. 15A across a frequency range of 650-950 MHz according to an exemplary embodiment; and

FIG. 15C is a chart illustrating the 3-dB beamwidth generated by the antenna array of FIG. 15A across a frequency range of 1700-2200 MHz according to an exemplary embodiment.

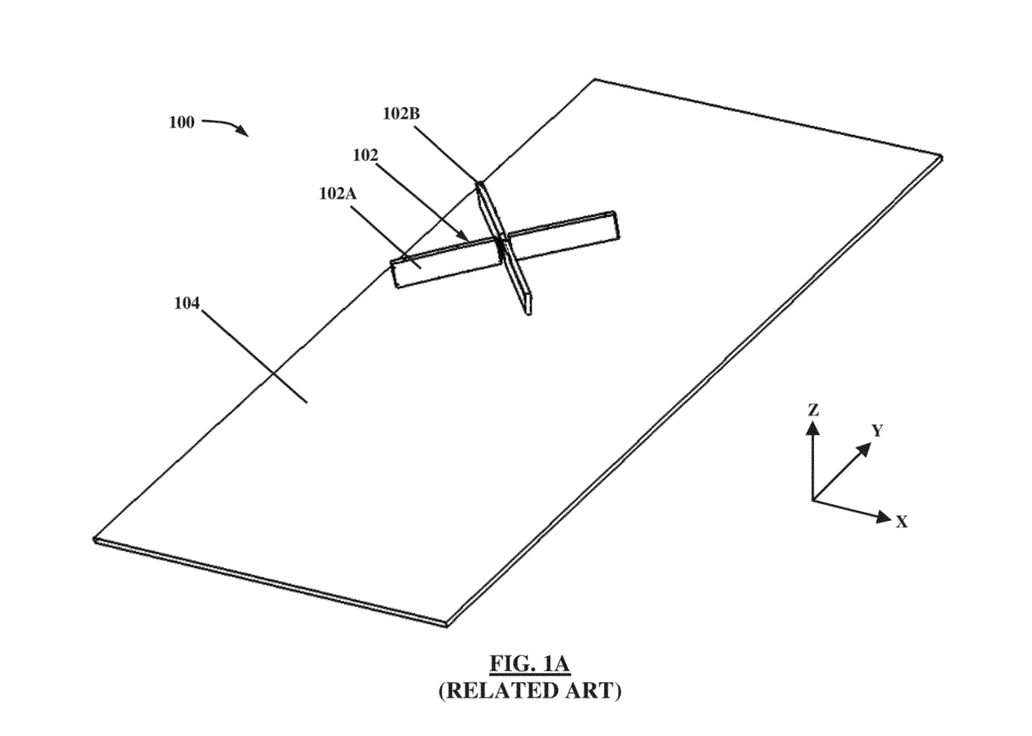

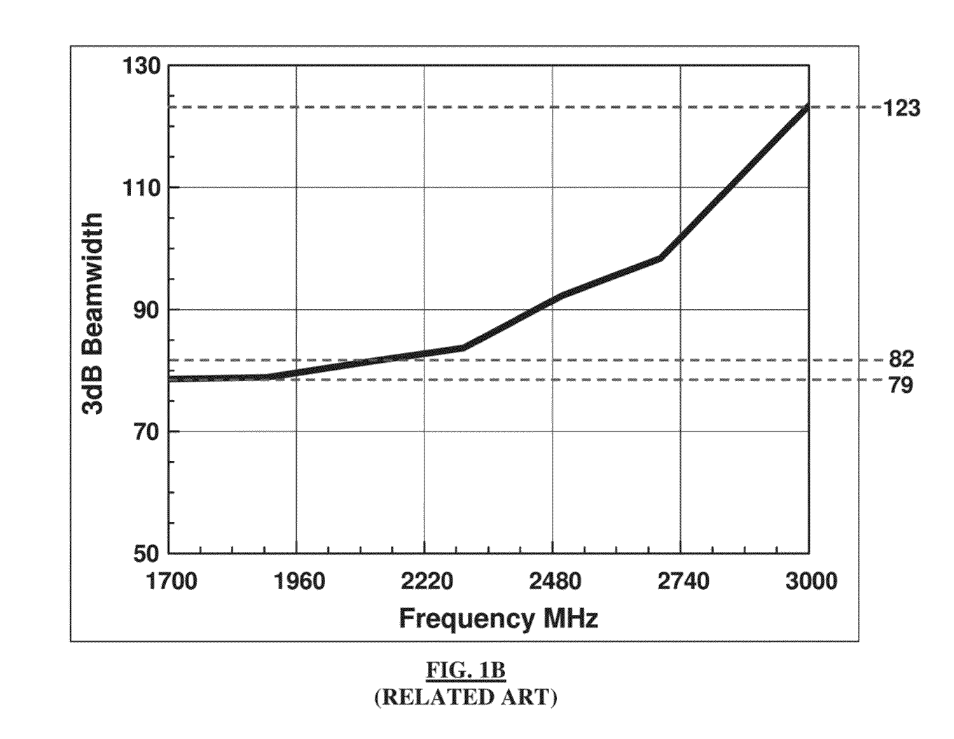

### DETAILED DESCRIPTION OF EXEMPLARY EMBODIMENTS

Wireless communication networks currently deployed in the 1700-2200 MHz frequency range (e.g., AWS, DCS, and PCS networks) require antennas that operate over a bandwidth of 28%, where bandwidth=(Fmax−Fmin)/(0.5*(Fmax+Fmin)). When that frequency range is expanded to include networks that operate with frequencies as high as 2690 MHz (e.g., IMT-E networks), the required bandwidth increases to 46%. Exemplary embodiments go even further by providing a wide bandwidth antenna that maintains a near-uniform azimuth beamwidth across as high as a 55% bandwidth. In the embodiments described below, the aforementioned 55% bandwidth is described by way of example as being provided in the 2200-3000 MHz frequency range. However, it will be understood by those having ordinary skill in the art that exemplary embodiments may be modified to provide similar performance enhancements in other frequency ranges without departing from the spirit of the inventive concept.

Exemplary embodiments offer great flexibility in antenna sharing, network deployment, and logistic planning. For example, antennas that operate across a large frequency band may communicate with networks operating on disparate frequencies using the same antenna, thus reducing the costs of installing base stations. Moreover, such antennas help future-proof base stations by allowing the addition of new networks that operate in different frequency bands, such as the networks currently being developed using the LTE standard (e.g., IMT-E networks).

The performance characteristics of the exemplary embodiments are achieved by providing slotted parasitic strips or slotted parasitic enclosures to control azimuth beamwidth and azimuth beamwidth dispersion across a very large frequency range. Beamwidth control is achieved by the optimum choice of the dimensions of the parasitic elements and the slots and/or conductive elements therein, their height in front of the ground plane, and their proximity to the radiating element(s). Thus, exemplary embodiments may be realized with many types of antenna arrangement without departing from the spirit of the inventive concepts. Several preferred embodiments are now described for illustrative purposes, it being understood that exemplary embodiments may be realized in other forms not specifically shown in the drawings.

### Parasitic Strips

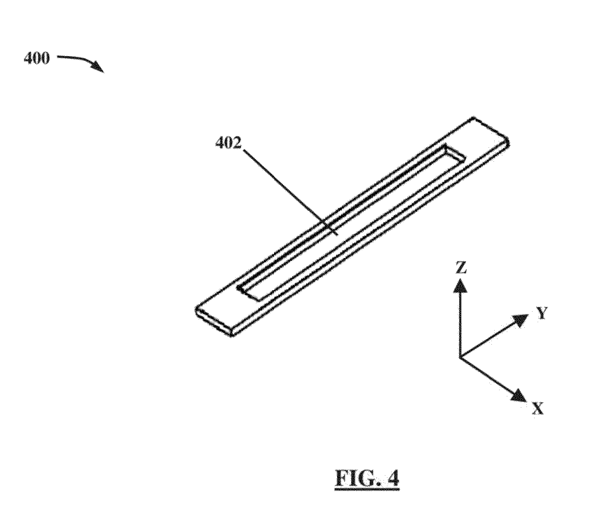

As FIG. 4 illustrates, one exemplary embodiment utilizes parasitic elements in the form of slotted elongate conductive parasitic strips 400 to control azimuth beamwidth and beamwidth dispersion across a wide range of frequencies. The slotted parasitic strip 400 comprises an elongate conductive member 401 having elongate openings, or slots, 402 disposed therein, preferably at a location centered between the lateral and longitudinal edges of the parasitic strip 401. The additional resonance generated by the slot 402 in the slotted parasitic strips 401 provides control over an additional band of frequencies within the total frequency range in which the antenna is configured to operate. Thus, azimuth beamwidth and beamwidth dispersion may be separately controlled at different bands within that frequency range by changing the length and location of the slotted parasitic strips 401 and/or the length of the slots 402 disposed therein, thereby providing beamwidth control over a larger total frequency range than is possible with a simple parasite as known in the related art.

The slotted parasitic strips 401 and the slots 402 are preferably approximately λ_{L}/2 long and λ_{H}/2, respectively, in the vertical direction, wherein λ_{L} is the free-space wavelength at a first (lower) frequency and λ_{H} is the free-space wavelength at a second (higher) frequency within the frequency band over which beamwidth control is sought. For example, if the length of the slotted parasitic strips 401 is chosen to control beamwidth in the 1700-2200 MHz band, it will be based on a wavelength λ_{L} of 154 mm (i.e. strip length=154/2 mm=77 mm). And if the length of the slots 402 is used to control the 2200-3000 MHz band, their length will be based on a wavelength λ_{H} of 118 mm (i.e., Slot Length=118/2 mm=59 mm). Because the length of a slot 402 cannot be greater than the length of the slotted parasitic strip 401 in which it is disposed, the length of the slotted parasitic strip 401 is generally used to control beamwidth at lower frequencies and the length of the slots 402 is generally used to control beamwidth at higher frequencies within the desired operating frequency range.

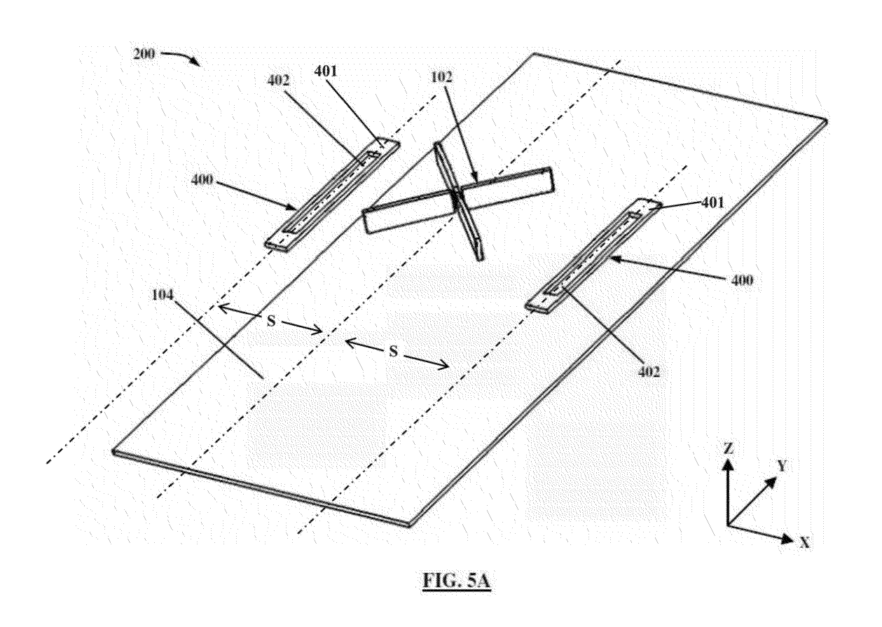

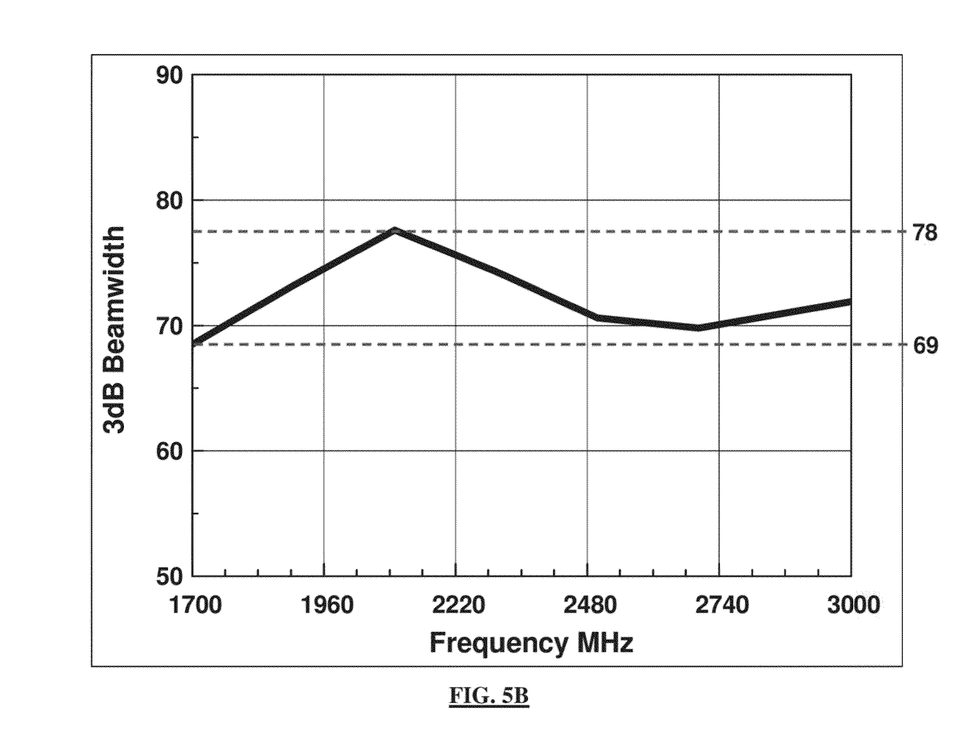

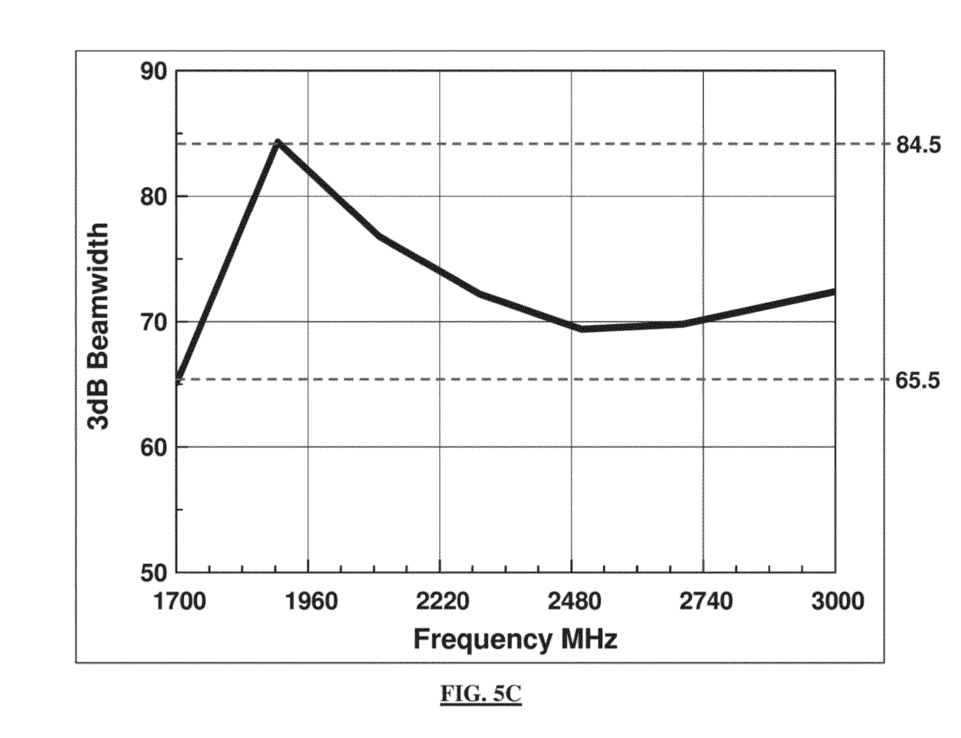

When used in an array 200 as illustrated in FIG. 5A operating over a single wide frequency range, the slotted parasitic strips 400 are typically provided as rectangular conductive strips with their respective longitudinal edges positioned vertically, i.e. parallel with the longitudinal edges of the ground plane 104 and with the plane of their largest cross-sectional area substantially parallel to the ground plane 104. The slotted parasitic strips 400 are disposed in front of the ground plane, preferably at a distance between 0.15λ_{F} and 0.3λ_{F} therefrom, wherein λ_{F} is the free-space wavelength at the mid-band frequency of the full frequency range over which the crossed dipole radiator 102 is configured to operate. The crossed dipole radiator 102 is preferably disposed in front of the ground plane a distance of about 0.25λ_{F}. The slotted parasitic strips 400 may be arranged in front of, behind, or in the same plane as the crossed dipole radiator 102, depending on the structure of the antenna.

The slotted parasitic strips 400 are preferably supported in front of the ground plane 104 using a non-conductive dielectric spacer (not shown), such as lightweight expanded plastic foam, so they are not galvanically connected to the ground plane 104. The crossed dipole radiator 102 is supported in front of the ground plane 104 by an arrangement (not shown) preferably incorporating a balanced-to-unbalanced transformer (balun) which may take many configurations according to the related art. The crossed dipole radiator 102 and slotted parasitic strips 400 are preferably formed from thin metal sheets or printed circuit boards (PCBs) and may be manufactured by any suitable process (e.g., stamping, milling, plating, etching, etc.).

The slotted parasitic strips 400 are typically positioned so that their central portions are approximately aligned in a frontal view with the center of the associated crossed dipole radiating element. The slotted parasitic strips 400 are located close to the crossed dipole radiator 102 in the lateral direction, preferably at a distance between 0.3λ_{F} and 0.5λ_{F} from the central portion of the crossed dipole radiator 102. Each dipole 102A and 102B of the crossed dipole radiator 102 is preferably about λ_{F}/2 long, but this dimension may be varied depending on the environment in which the crossed dipole radiator 102 is configured to operate. The ground plane 104 is a conductive plate that is preferably about λ_{F} wide along its horizontal edge (parallel with the x-axis).

The configuration described above is intended to yield an average azimuth beamwidth of about 65°, which provides optimum performance for the most common requirements of wireless communication networks. By choosing the appropriate configuration of the radiating elements and parasites, however, an average azimuth beamwidth value may be chosen to lie anywhere between 33° and 120°. While slotted parasitic strips 401 and the slots 402 therein are described above by way of example as being rectangular, they may be of any suitable elongate shape able to resonate in the desired manner when excited by radiation from the crossed dipole 102. In certain exemplary embodiments, each of the parasitic strips 400 may be supported by an elongate conductive element attached at its longitudinal mid-point.

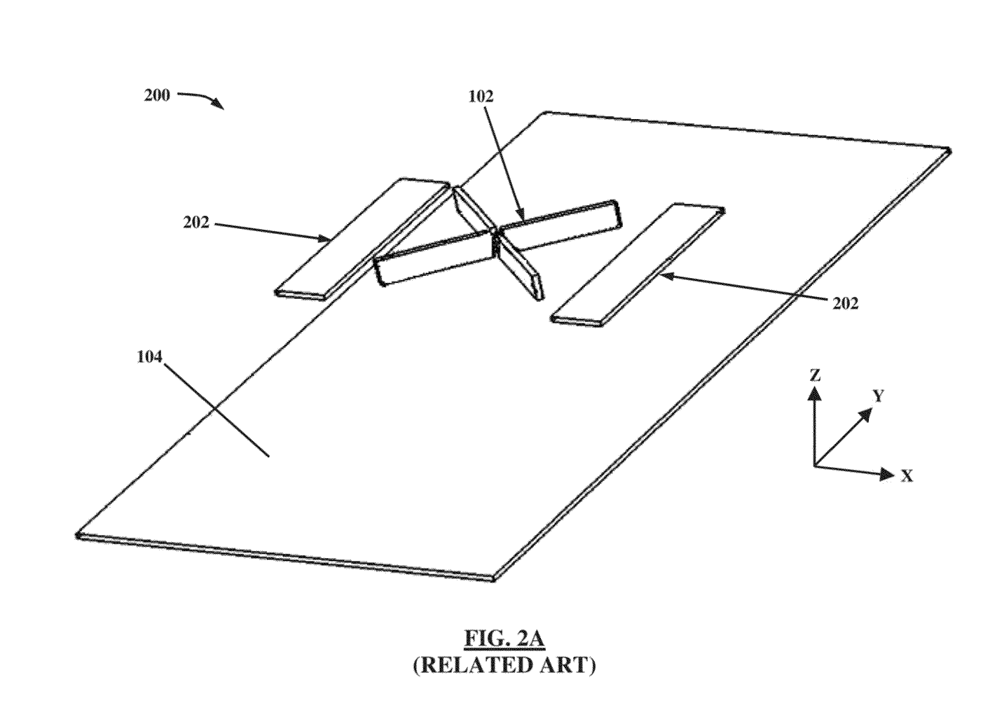

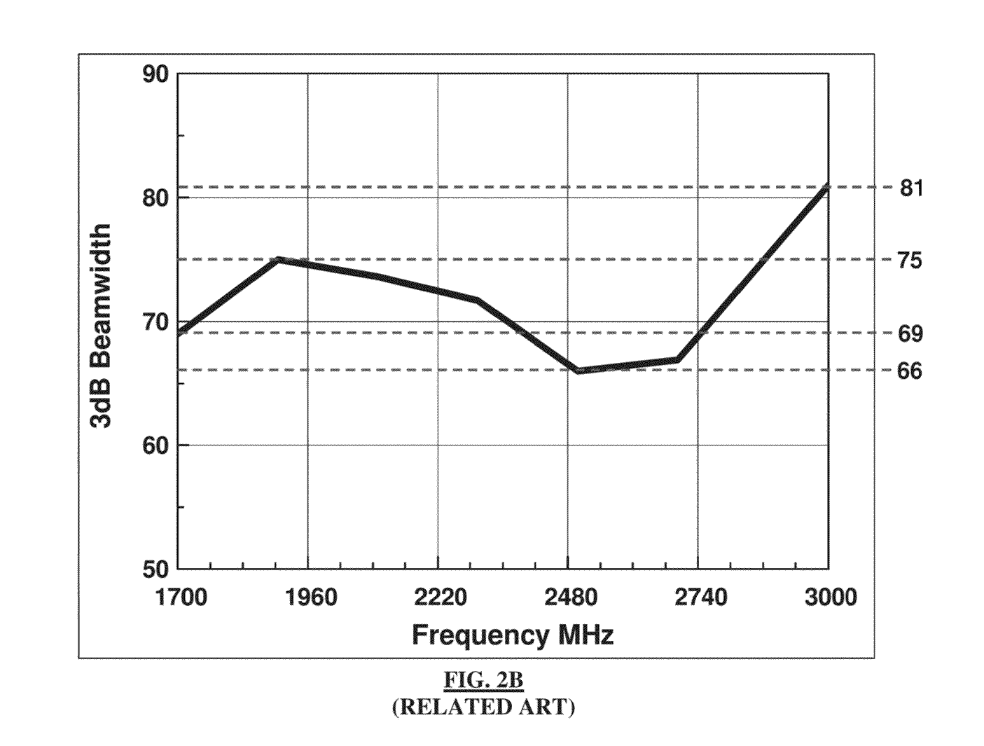

The additional degree of control provided by the slots 402 within the slotted parasitic strips 401 in the wide-band array 200 of FIG. 5A provides better performance characteristics than the related art parasitic strips 202 in the wide-band array 200 of FIG. 2A. In operation, both the slotted strips 401 and the slots 402 are excited parasitically by the crossed dipole radiator 102. Based on the chosen dimensions of the slotted strips 401 and the slots 402, the slotted strips 401 and the slots 402 resonate at different frequencies. The additional resonance generated by the slots 402 within the parasitic strips 401 provides control over a second frequency band within the total frequency range over which the crossed dipole radiator 102 is configured to operate. Thus, as discussed above, different frequency ranges may be controlled by changing the length and location of the parasitic strips 401 as well as the length and location of the slots 402 disposed therein.

By way of example, the length of the slotted parasitic strips 400 may be adjusted to maintain low azimuth beamwidth dispersion in the 1700-2200 MHz frequency range while the length of the slots 402 is adjusted to further reduce dispersion in the 2200-3000 MHz frequency range.

As FIG. 5B illustrates, the provision and optimization of the slotted parasitic strips 401 and slots 402 in the wide-band array 200 of FIG. 5A reduces the azimuth beamwidth and beamwidth dispersion compared to the related art parasitic strips 202 of the single-band array 200 of FIG. 2A. In particular, the length of the slots 402 reduces dispersion in the 2200-3000 MHz frequency range. Accordingly, a comparison of FIG. 2B with FIG. 5B illustrates that beamwidth dispersion is reduced from 15° (81°−66°=15°) to 9° (78°−69°=9°) across that frequency range. The slotted parasitic strips 400 of the wide-band array 200 of FIG. 5A also maintain more constant gain across the 1700-2200 MHz frequency range than the related art parasitic strips 202 of the single-band array 200 of FIG. 2A.

To obtain the results illustrated in FIG. 5B, the length of the slotted parasitic strips 401 was based on a wavelength λ_{L} of 154 mm for the 1700-2200 MHz band (i.e., Length=λ_{L}/2=77 mm), and the length of the slots 402 was based on a wavelength λ_{H} of 130 mm for the 2200-3000 MHz band (i.e., Length=λ_{H}/2=65 mm). By increasing the length of the slots 402, they may also be used to affect the 1700-2200 MHz band, as illustrated in FIG. 5C. To obtain the results illustrated in FIG. 5C, the length of the slots 402 was based on a wavelength λ_{H} of 150 mm (i.e., Length=λ_{H}/2=75 mm).

### Antennas Covering Non-Contiguous Extended Frequency Ranges

According to the related art, antennas operating in two non-contiguous frequency ranges typically utilize two separate radiating elements each configured to operate within one of the two non-contiguous frequency ranges. A related art “dual-band” array 600 may include two separate crossed dipole radiators 102 and 602 configured to operate within two separate frequencies ranges (e.g., 695-960 MHz and 1710-2700 MHz).

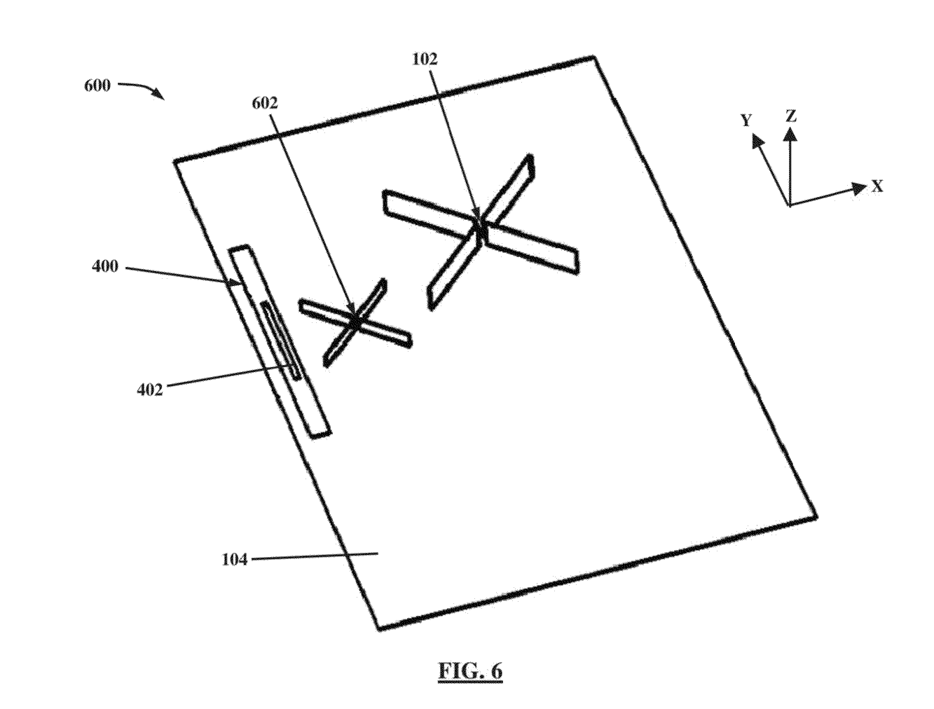

FIG. 6 illustrates an improved multi-band array 600 according to another exemplary embodiment, wherein the crossed dipole radiator 602 that is configured to operate within the higher frequency range is disposed laterally between a second crossed dipole radiator 102 and a slotted parasitic strip 400.

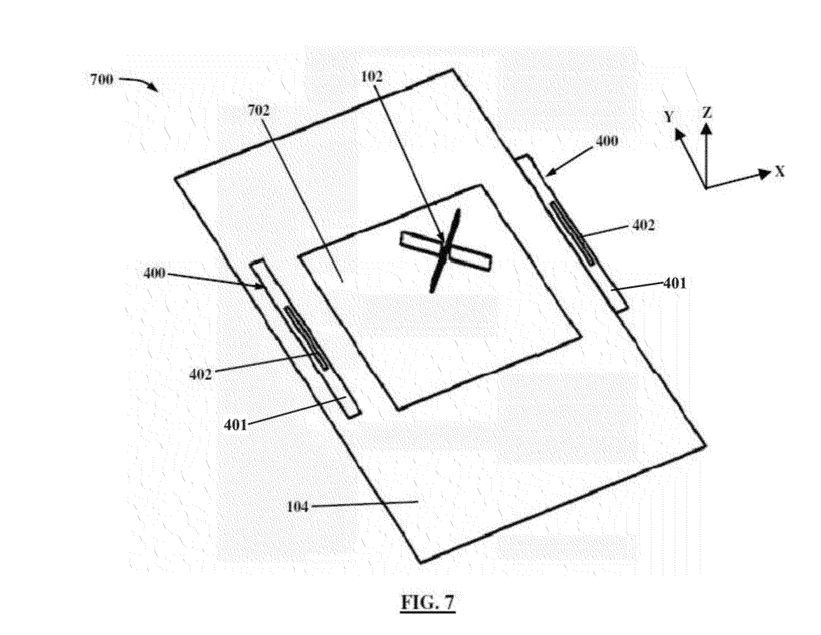

FIG. 7 illustrates a multi-band array 700 according to another exemplary embodiment. Array 700 includes a patch radiator 702 configured to operate within a low frequency range (e.g., 695-960 MHz) and a crossed dipole radiator 102 configured to operate within a high frequency range (e.g., 1710-2700 MHz). The patch radiator 702 is disposed between the crossed dipole radiator 102 and the ground plane 104 such that the patch 702 acts as a ground plane or reflector for the crossed dipole radiator 102. The slotted parasitic members 400 are laterally disposed on both sides of the radiating elements to better control the azimuth beamwidth and beamwidth dispersion in both operating frequency ranges.

As with the wide-band array 200 of FIG. 5A, the array 600 of FIG. 6 and the array 700 of FIG. 7 include parasitic strips 401 configured to control the lower frequency ranges and slots 402 within the parasitic strips 401 configured to control the non-contiguous higher frequency ranges. For example, using the exemplary frequencies described above with respect to the arrays 600 and 700, each parasitic strip 401 has a length based on a wavelength) λ_{L} of 360 mm for the 695-960 MHz frequency range (i.e., Length=λ_{L}/2=180 mm) and each slot 402 therein has a length based on a wavelength λ_{H} of 136 mm for the 2170-2700 MHz band (i.e., Length=λ_{H}/2=68 mm).

When used in an array 600 or 700 as described above, the parasitic strips 401 and the corresponding slots 402 therein provide control over azimuth beamwidth and beamwidth dispersion in two extended non-contiguous frequency bands in a similar manner to that discussed above with respect to contiguous frequency bands and the wide-band array 200. Thus, the slotted parasitic strips 400 may be used not only to improve performance characteristics across a wider frequency range in a wide-band array (e.g., 2200-3000 MHz), they may also be used to improve performance characteristics across different frequency ranges in multi-band arrays (e.g., 695-960 MHz and 1710-2700 MHz).

### Parasitic Enclosure

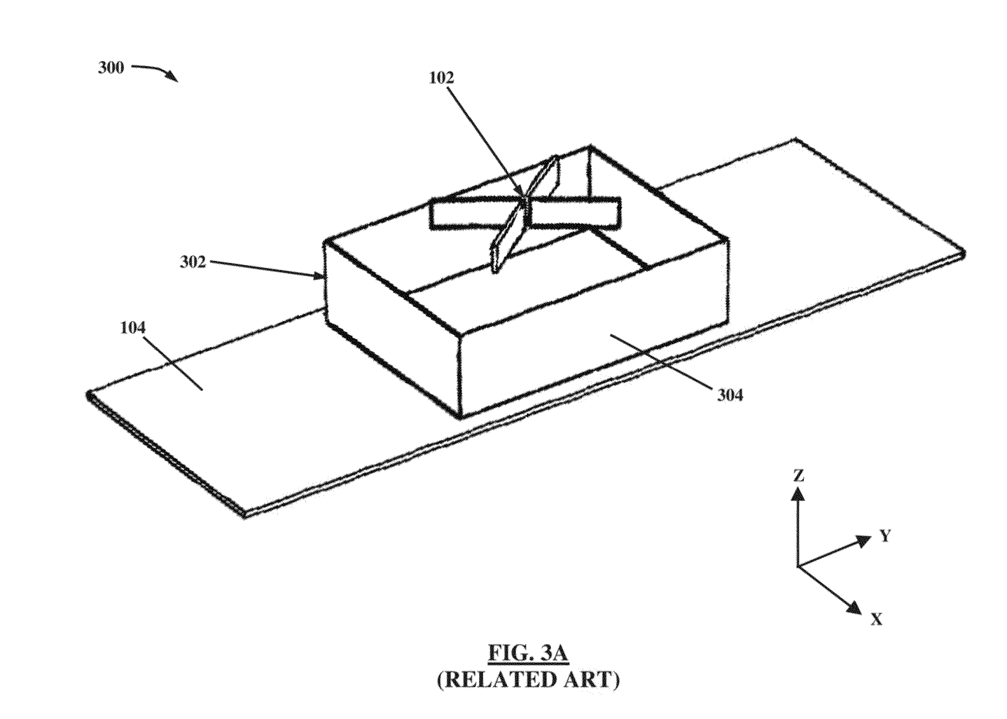

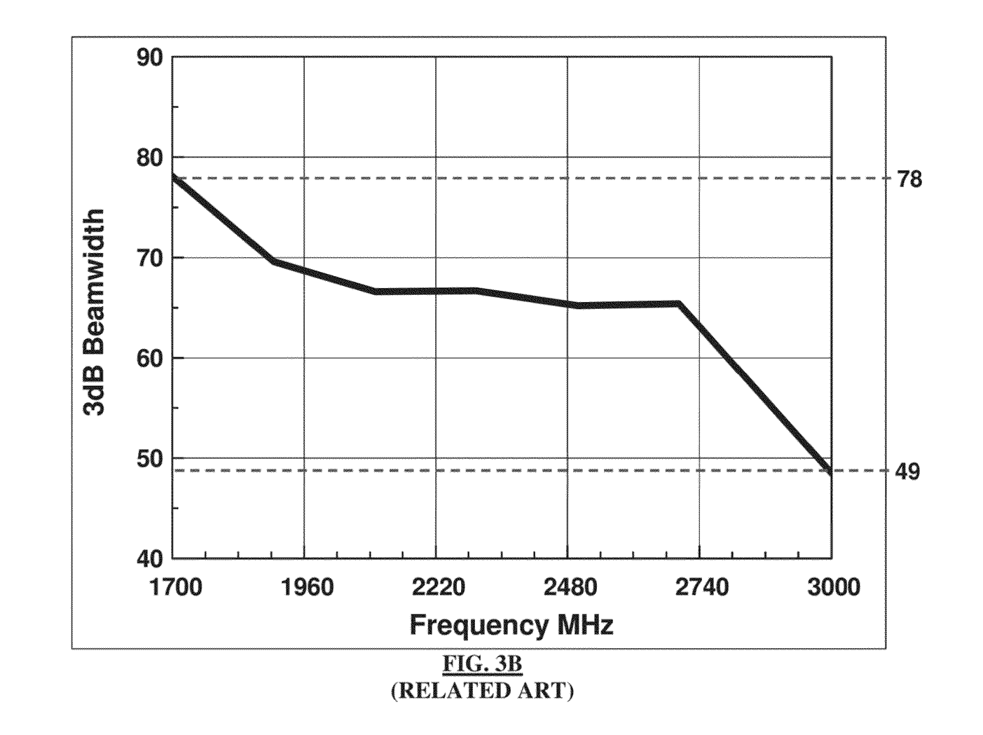

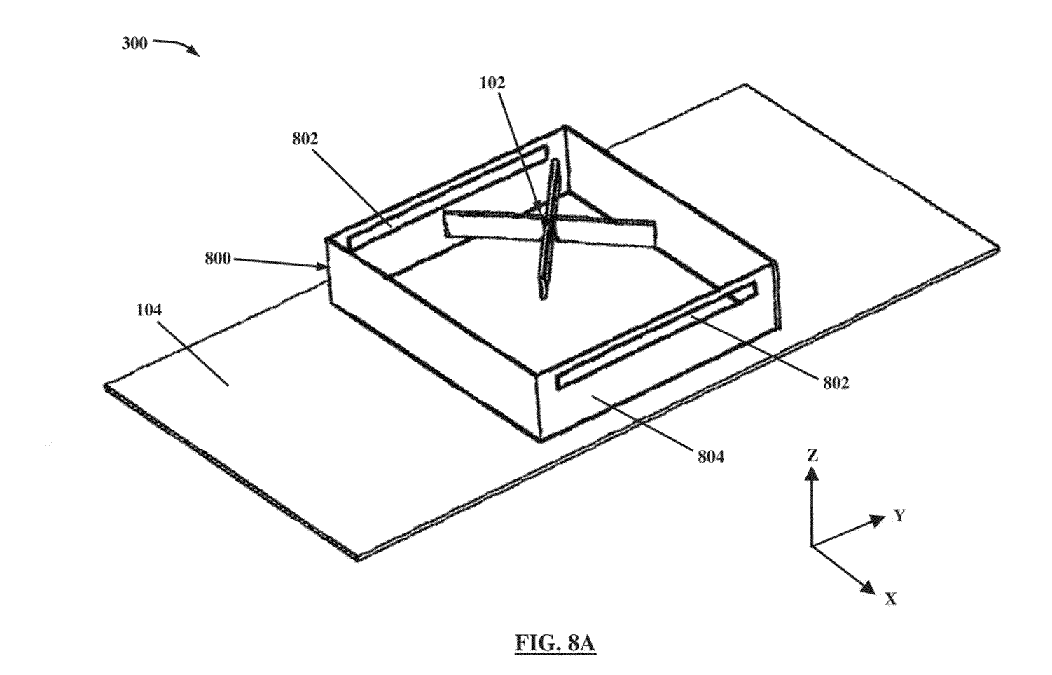

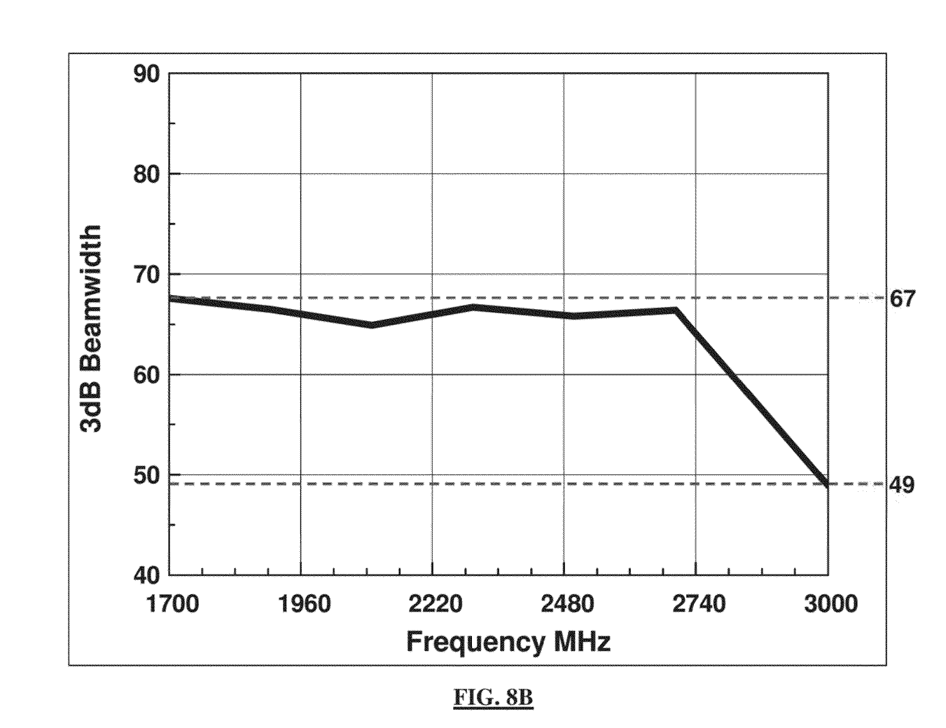

As discussed above, some related art base station antennas utilize a boxed configuration 300, wherein the radiating element 102 is surrounded by a conductive box structure 302. Although such structures allow some degree of control over beamwidth through choice of the width and height of the box structure 302, conventional box structures 302 are not capable of providing low beamwidth dispersion across a wide bandwidth (e.g., a 55% bandwidth). FIGS. 8A-12 illustrate other exemplary embodiments that improve the performance characteristics of the related art boxed structure 302 of FIG. 3A by providing a modified box structure 800 that includes shaped openings, or slots, 802 formed in the two vertical sides 804 thereof.

FIG. 8A illustrates a square conductive box structure 800 connected to the ground plane 104. The box structure 800 includes four sides 804 that are substantially parallel with the lateral and longitudinal edges of the ground plane and that extend substantially perpendicular from the ground plane. The crossed dipole radiator 102 is disposed between the sides 804 of the box structure 800 so that the crossed dipole radiator 102 is surrounded on four sides by the box structure. The crossed dipole radiator 102 may be enclosed by a radome (not shown) so as to shield antenna components within the box structure 800 from inclement weather. The slots 802 are disposed in the sides 804 of the box structure 800 on opposite sides of the crossed dipole radiator 102.

As FIG. 8A illustrates, the sides 804 of the box structure 800 are substantially equal in length, preferably each about 0.77λ_{F} long. The length of each dipole 102A and 102B of the crossed dipole radiator 102 is preferably about 0.5λ_{F}. Each dipole 102A and 102B may also be slightly longer or slightly shorter than 0.5λ_{F} depending on the environment in which the crossed dipole radiator 102 is configured to operate. The linear slots 802 are preferably approximately 0.5λ_{F} in length so as to resonate at approximately the same frequency as the signal radiated by the crossed dipole. The aforementioned configuration is intended to yield an average azimuth beamwidth of about 70°±6° in the 1710-2170 MHz frequency range.

The slots 802 are provided in the two vertical faces 804 of the box structure 800 in order to create an array of active radiating elements and parasitic radiators in the horizontal plane. The linear slots 802 may also be provided in the upper and lower faces 804 of the box structure 800, but because the boxed configurations 800 are arranged in a vertical linear array in a base station antenna, the influence of horizontal slots disposed in the horizontal faces 804 of the box structure 800 will not be as dominant as the influence of vertical slots 802 disposed in the vertical faces 804 of the box structure 800. Thus, horizontal slots generally are not utilized in the upper and lower faces 804 of the box structure 800.

The slots 802 of the modified box structure 800 add a degree of control over azimuth beamwidth and azimuth beamwidth dispersion in the boxed configuration 300 such that, by changing the length and location of the slots 802, the average value of the azimuth beamwidth and the beamwidth dispersion may be modified at different bands within the frequency range of an antenna. For example, a comparison of FIG. 3B with FIG. 8B illustrates that the slots 802 reduce the azimuth beamwidth at several frequencies (e.g., from 80° to 67° at 1700 MHz) and that the beamwidth dispersion is reduced from 29° (78°−49°=29°) to 18° (67°−49°=18°).

The linear slots 802 improve the azimuth beamwidth dispersion without compromising several other key operating characteristics, such as the voltage standing wave ratio (VSWR), isolation, gain, and elevation pattern shaping. However, they cause some unwanted radiation to be transmitted towards the rear of the antenna, which reduces the front-to-back ratio of the azimuth radiation pattern. The front-to-back ratio is defined as the ratio of the power radiated in the forward direction (aligned with the axis of the antenna) to the power radiated rearwards. Thus, a lower front-to-back ratio means that more unwanted radiation is being transmitted at the rear of the main lobe (i.e., the rear of the boxed configuration 300). Energy radiated outside the main beam of the azimuth radiation pattern may cause interference with signals from other base stations, so the rate of change of signal power with azimuth angle outside the main beam (the rate of roll-off) is an important consideration in antenna design.

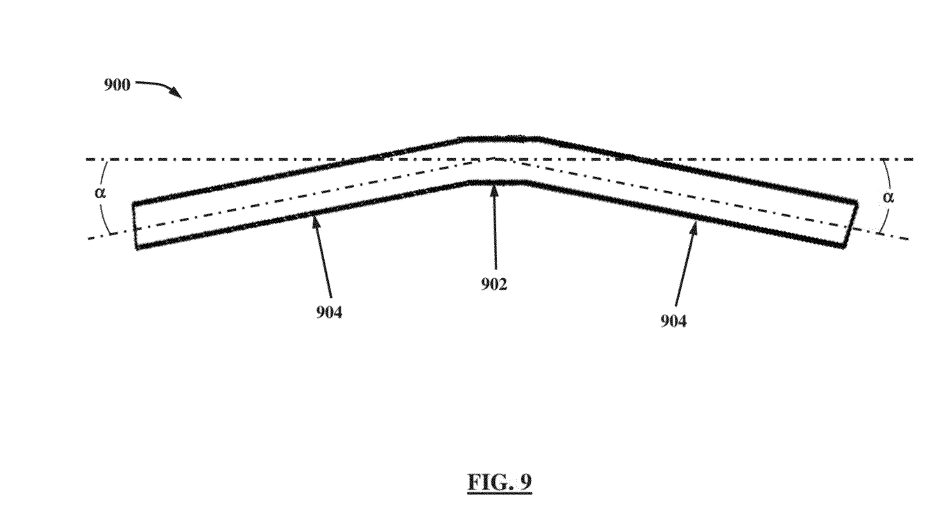

According to exemplary embodiments, FIG. 9 illustrates angled slots 900 that provide improved front-to-back ratio and more rapid azimuth roll-off than linear slots 802 illustrated in FIG. 8A.

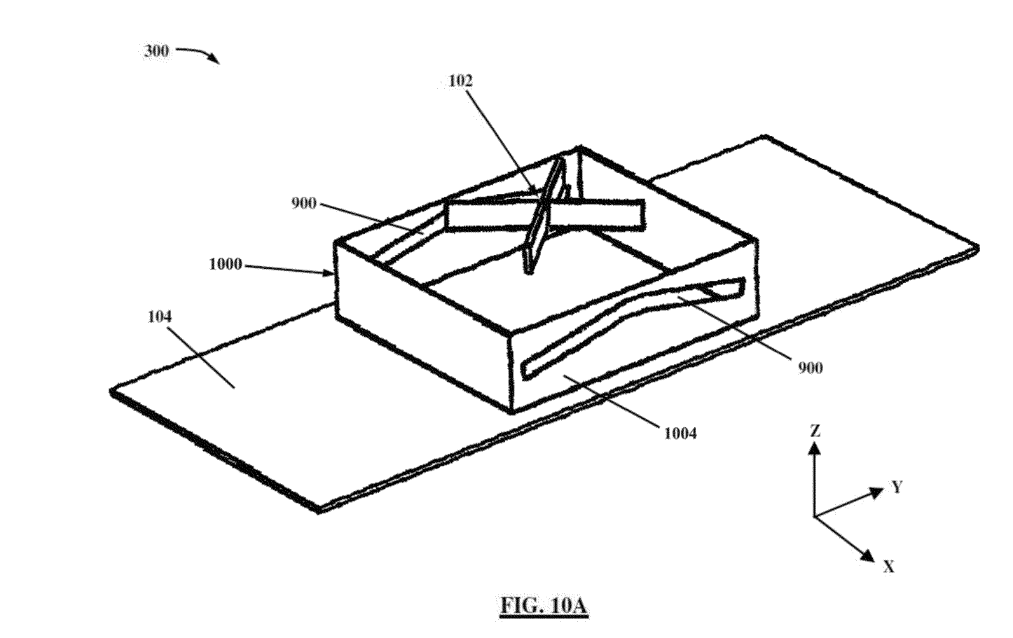

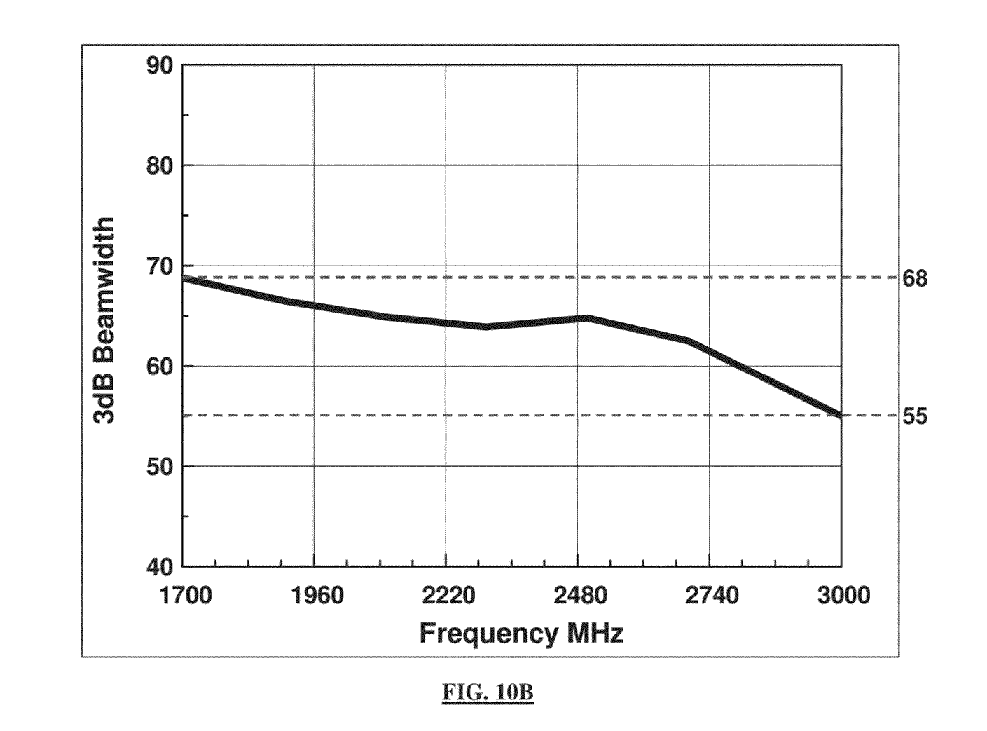

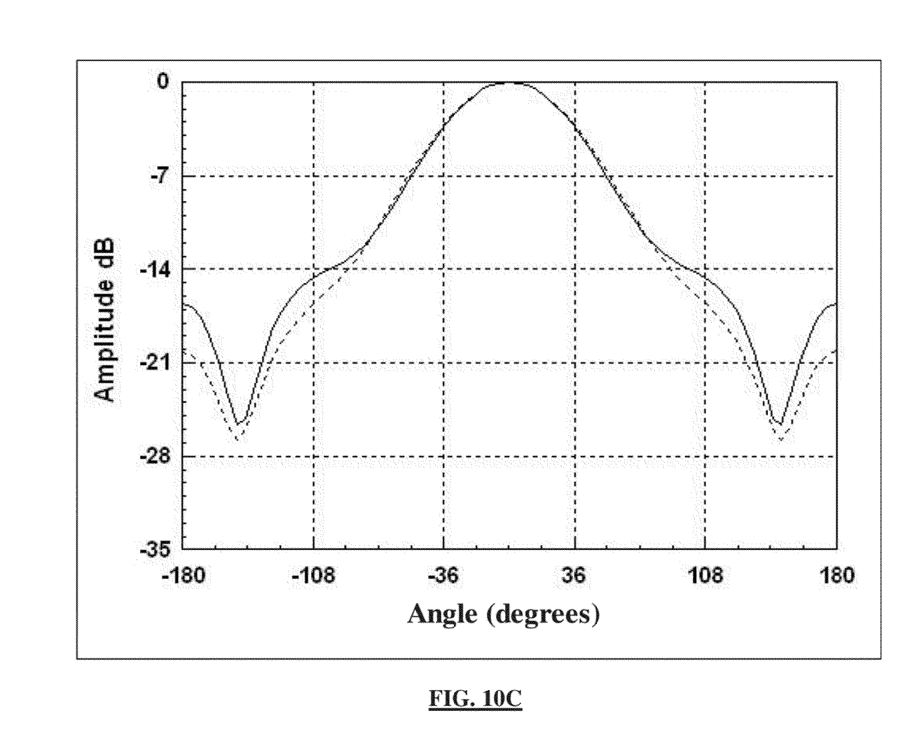

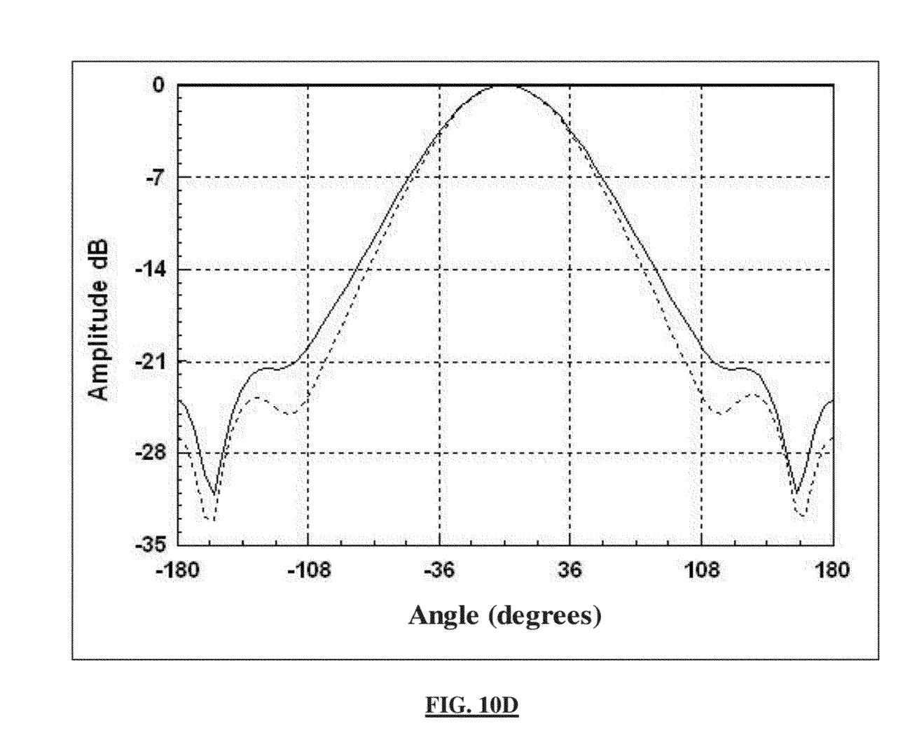

FIG. 10 illustrates a modified box structure 1000 that includes angled slots 900 as illustrated in FIG. 9. Similar to the linear slots 802 in the modified box structure 800 illustrated in FIG. 8A, the angled slots 900 illustrated in FIG. 10A are disposed in the vertical faces 1004 of the box structure 1000 on both sides of the crossed dipole radiator 102 so as to create a lateral array of elements whose largest dimension is in the horizontal plane. Unlike the linear slots 802 illustrated in FIG. 8A, the angled slots 900 are bent and angled backward toward the ground plane 104 at their distal ends so as to substantially form the shape of a flattened “V”, or a boomerang.

The angled slots 900 formed within the planar conductive faces 1004 may include a central linear slotted portion 902 having a pair of elongate linear slots 904 extending from opposing sides of the central portion 902 at an angle α° from the vertical. The central portion 902 may extend substantially parallel to the ground plane. The angle α is adjusted to optimize the front-to-back ratio and azimuth roll-off. Dependent upon the dimensions of the modified box structure and the location of the angled slots 900, it is found sometimes to be desirable to use negative angles for a such that the angled slots 900 are angled away from the groundplane 104 at their distal ends. In the configuration illustrated in FIG. 10A, the angle of the angled slots 900 has been optimized at +11° for the 1700-2200 MHz frequency range.

The angled slots 900 in the modified box structure 1000 of FIG. 10A maintain the improved azimuth beamwidth and beamwidth dispersion achieved by the linear slots 802 of the box structure 800 of FIG. 8A while also increasing the front-to-back ratio and the rate of azimuth roll-off. For example, a comparison of FIG. 3B with FIG. 10B illustrates that the angled slots 900 reduce the beamwidth at several frequencies (e.g., from 78° to 68° at 1700 MHz) and that the beamwidth dispersion is reduced from 29° (78°−49°=29°) to 13° (68°−55°=13°). Furthermore, as FIGS. 10C and 10D illustrate, the angled slots 900 also increase the front-to-back ratio and rate of azimuth roll-off.

FIGS. 10C and 10D illustrate the radiation patterns generated by the box structure 800 of FIG. 8A and the modified box structure 1000 of FIG. 10A. The radiation patterns generated by the linear slots 802 in the box structure 800 of FIG. 8A are represented as a solid line, and the radiation patterns generated by the angled slots 900 in the modified box structure 1000 of FIG. 10A are represented as a dashed line. FIG. 10C illustrates those radiation patterns at 1700 MHz, and FIG. 10D illustrates those radiation patterns at 2200 MHz. In both figures, the 3-dB beamwidth is the same and the improved performance characteristics, which are a direct result of angling the distal ends of the angled slots 900, are illustrated in FIGS. 10C and 10D.

The improved performance characteristics provided by both the linear slots 802 in the box structure 800 of FIG. 8A and the angled slots 900 in the faces 1004 of the box structure 1000 of FIG. 10A may be improved further by adding an elongate conductive parasitic strip within those slots. As with the slots 402 within the slotted parasitic strips 400 discussed above, the addition of conductive parasitic strips within the linear slots 802 in the modified box structure 800 of FIG. 8A or the angled slots 900 in the modified box structure 1000 of FIG. 10A adds an additional degree of control over azimuth beamwidth and beamwidth dispersion. In particular, the parasitic strip configured within the slots allows azimuth beamwidth and beamwidth dispersion to be controlled across a wider frequency range.

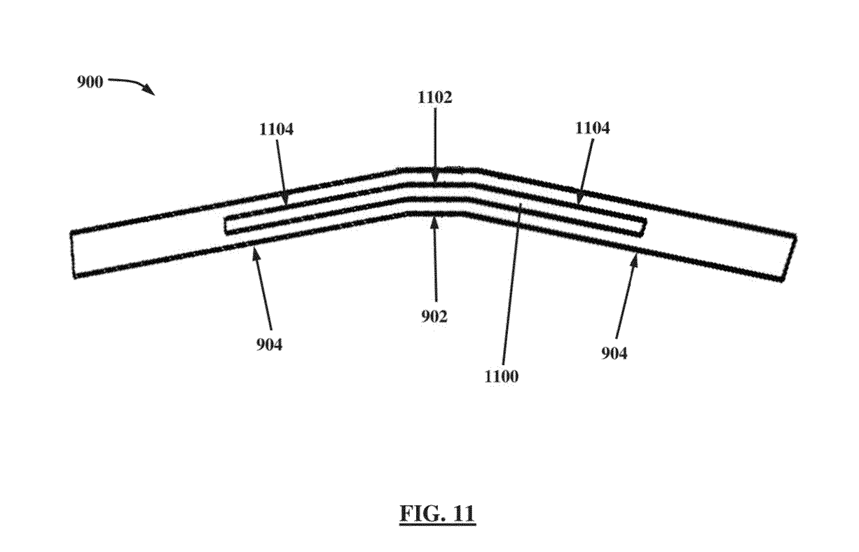

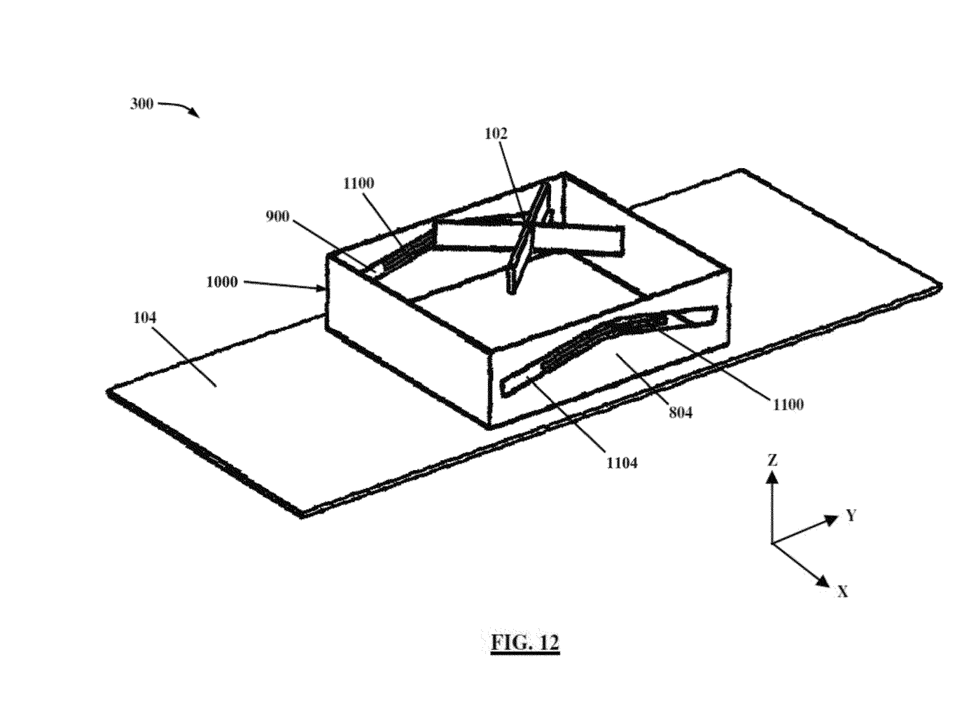

FIGS. 11 and 12 illustrate the modified box structure 800 of FIG. 10A further modified to include an angled conductive parasitic strip 1100 disposed within the angled slots 900. The angled parasitic strips 1100 are preferably disposed within the angled slots 900 at a location centered within the angled slots 900. As FIG. 11 illustrates, the angled parasitic strips 1100 may include a central portion 1102 within the central portion 902 of the angled slots 900 and a pair of elongate arms 1104 extending from opposing sides of the central portion 1102 at the same angle α as the arms 904 of the angled slots 900 so there is substantially constant clearance between the edges of the angled parasitic strips 1100 and those of the angled slots 900.

The angled parasitic strips 1100 provide an additional degree of control over azimuth beamwidth and beamwidth dispersion by generating an additional resonance when they are excited parasitically by the crossed dipole radiator 102. Accordingly, as discussed above with respect to FIGS. 4-7 the respective lengths of the angled slots 900 and angled parasitic strips 1100 may be chosen as required to control different frequency ranges within the total frequency range in which the crossed dipole radiator 102 is configured to operate, and their angle α relative to the vertical may be adjusted to increase front-to-back ratio and azimuth roll-off.

The angled slots 900 and their respective angled parasitic strips 1100 provide substantially the same functionality as described above with respect to the slotted parasitic conductive strips 400 and their respective slots 402. However, because the angled parasitic strips 1100 are disposed within the angled slots 900, the length of the angled parasitic strips 1100 cannot be larger than the length of the angled slots 900. Accordingly, in the embodiment illustrated in FIG. 12, the length of the angled slots 900 will generally be used to control lower frequency ranges and the length of the angled parasitic strips 1100 will generally be used to control upper frequency ranges. Thus, instead of having a length based on the free-space wavelength at the mid-band frequency of the full frequency range over which the crossed dipole radiator 102 is configured to operate, the angled slots 900 and angled parasitic strips 1100 will have lengths based on the frequency ranges over which they will each control azimuth beamwidth and beamwidth dispersion (e.g., λ_{L}/2 for the angled slots 900 and λ_{H}/2 for the angled parasitic strips 1100).

The additional degree of control provided by such angled parasitic strips 1100 not only allows the modified box structure 1000 of FIG. 12 to control azimuth beamwidth and beamwidth dispersion over a wider bandwidth in a wide-band array, it also enables control of azimuth beamwidth and beamwidth dispersion in two non-contiguous frequency bands (e.g., 695-960 MHz and 1710-2700 MHz) in a similar manner to that discussed above with respect to the multi-band arrays 600 and 700 of FIGS. 6 and 7. Accordingly, the boxed configuration 300 of FIG. 12 may be modified as required to accommodate such multi-band arrays.

### Nested Angled Slots

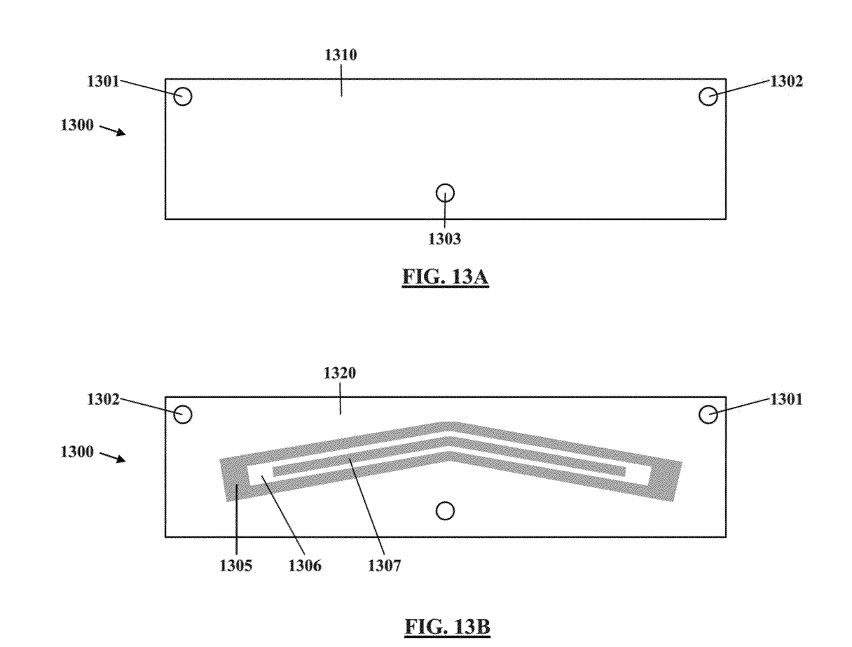

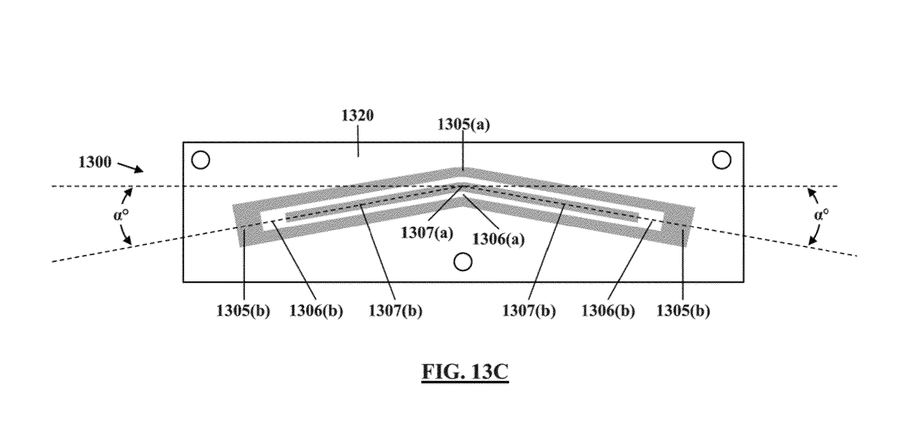

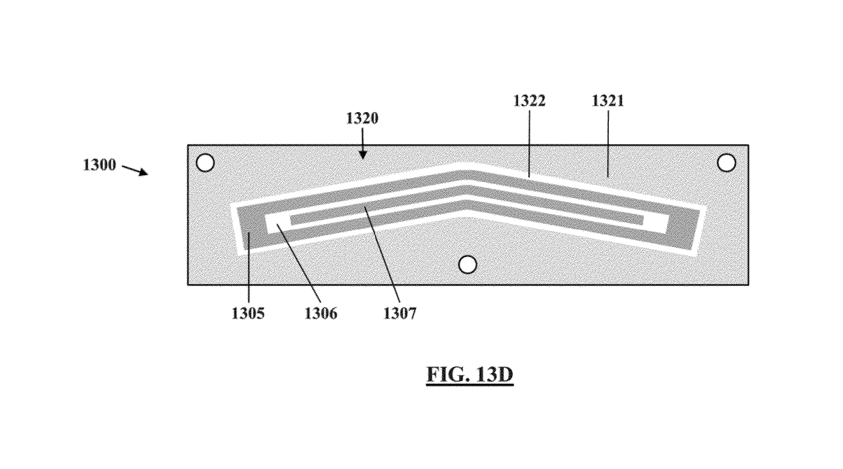

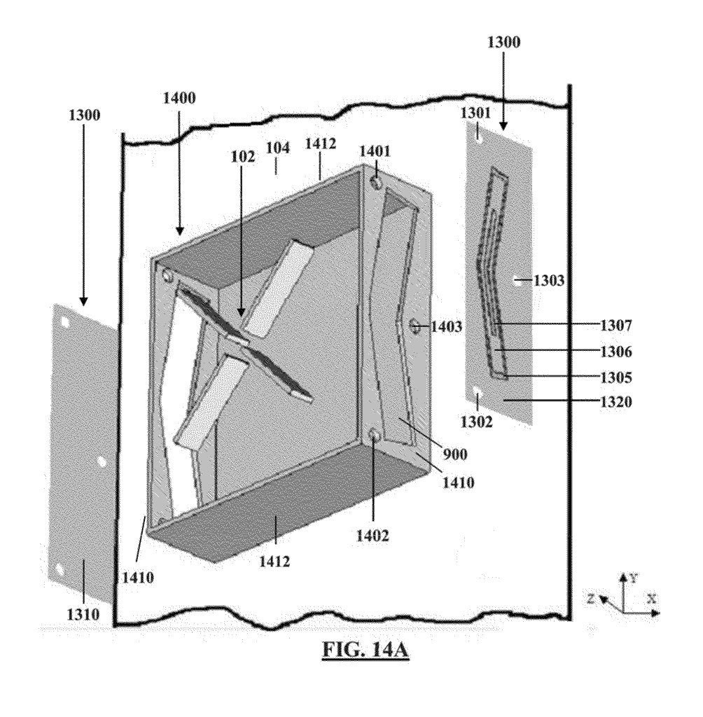

In order to control azimuth beamwidth and beamwidth dispersion over a wider bandwidth in a wide-band array—or to control the azimuth beamwidth and beamwidth dispersion in two wider non-contiguous frequency bands—slots and conductive parasitic elements may be nested. In the exemplary embodiment illustrated in FIGS. 13A and 13B a thin, flat rectangular printed circuit board 1300 has one unclad face 1310, shown in FIG. 13A, having no conductive surface and a second face 1320 with conductive features formed on it as shown in FIG. 13B. The printed circuit board 1300 may include holes 1301, 1302, and 1303 to provide means of attachment to the face 1004 of the box structure 1000.

FIG. 13B illustrates the clad face 1320 on the reverse side of the printed circuit board 1300 of FIG. 13A, which has been modified to include conductive parasitic elements according to an exemplary embodiment. On the face 1320 there are formed, by etching printing or other means, angled conductive parasitic elements 1305 and 1307. The outer parasitic conductive element 1305 has formed within it a non-conductive area 1306, which in turn has formed within it a further angled conductive parasitic element 1307.

The angled conductive parasitic elements 1305 and 1307 and the angled non-conductive area 1306 are bent and angled at their distal ends so as to substantially form the shape of a, flattened “V”, or a boomerang. As illustrated in FIG. 13C, the angled conductive parasitic element 1305 may include a central region 1305(a) substantially parallel to the longer sides of the rectangular printed circuit board 1300 and a pair of elongate linear regions 1305(b) extending from opposing sides of the central region 1305(a) at the angle α from the vertical. The angled non-conductive area 1306 may include a central region 1306(a) substantially parallel to the longer sides of the rectangular printed circuit board 1300 and a pair of elongate linear regions 1306(b) extending from opposing sides of the central region 1306(a) at an angle α from the vertical. The inner angled conductive area 1307 may include a central region 1307(a) substantially parallel to the longer sides of the rectangular printed circuit board 1300 and a pair of elongate linear regions 1307(b) extending from opposing sides of the central region 1307(a) at the angle α from the vertical.

Because each of the elongate linear regions 1305(b), 1306(b), and 1307(b) are preferably vertically disposed at the same angle α from the vertical, the sides of the elongate linear regions 1305(b), 1306(b), and 1307(b) are all substantially parallel. The angle α may be any angle greater than 0, preferably 10 degrees or greater. Accordingly, the longitudinal axis of each of the elongate linear regions 1305(b), 1306(b), and 1307(b) are vertically disposed at an angle greater than or equal to 20 degrees relative to the longitudinal axis of the opposite elongate linear regions. As described above with reference the angled slot 900 of FIG. 10A, angle α may be adjusted to optimize the front-to-back ratio and azimuth roll-off. In the configuration illustrated in FIGS. 13B-13C, the angle α of the elongate linear regions 1305(b), 1306(b), and 1307(b) has been optimized at 11 degrees for the 1700-2200 MHz frequency range.

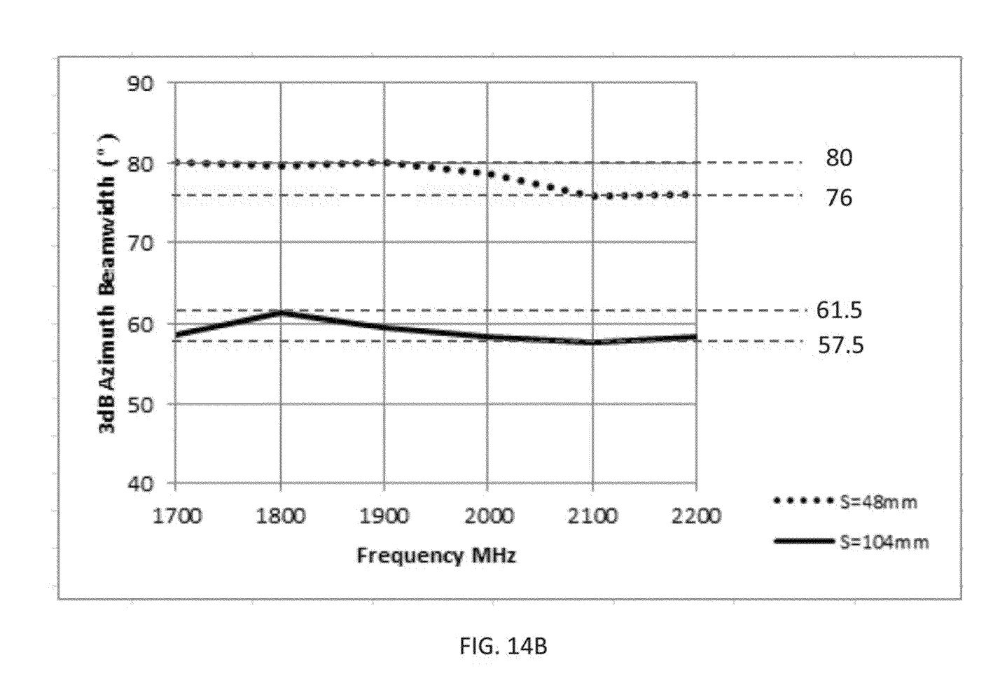

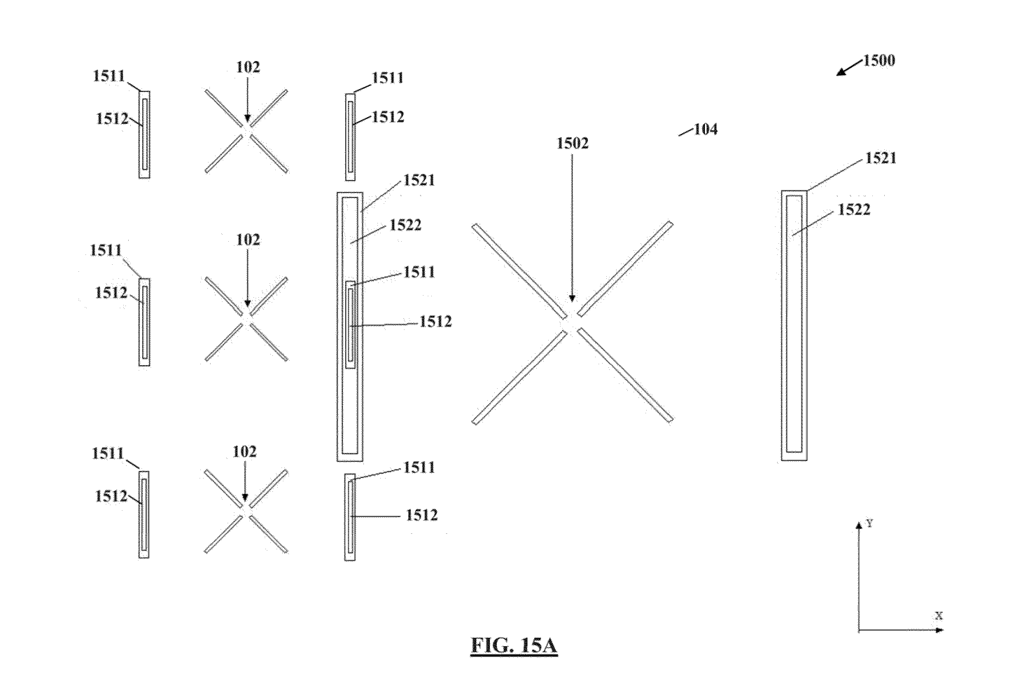

FIG. 14A illustrates a rectangular box structure 1400 and two printed circuit boards 1300 according to exemplary embodiments. The box structure 1400 includes a crossed dipole radiator 102 enclosed on four sides by faces 1410 and 1412. As described above, the crossed dipole radiator 102 includes a pair of dipoles positioned at a 45° angle relative to the sides of the rectangular box structure 1400 and located in front of a planar conductive ground plane 104. The two lateral faces 1410 of the box structure 1400 include angled openings 900.

As FIG. 14A illustrates, the sides 1410 and 1412 of the box structure 1400 are substantially equal in length, preferably each about 0.77λ^{F} long, wherein λ_{F} is the free-space wavelength at the mid-band frequency of the full frequency range over which the crossed dipole radiator 102 is configured to operate. The length of each dipole of the crossed dipole radiator 102 is preferably about 0.5λ_{F}. Each dipole may also be slightly longer or slightly shorter than 0.5λ_{F} depending on the environment in which the crossed dipole radiator 102 is configured to operate. The two printed circuit boards 1300 are affixed to the sides 1410 of the box structure 1400. For example, the insulating layers 1310 of the printed circuit boards 1300 may be affixed to the sides 1410 of the box structure 1400 while the conductive layers 1310, conductive parasitic elements 1305 and 1307, and the non-conductive area 1306 face outward. For example, the printed circuit boards 1300 may be affixed to the sides 1410 of the box structure 1400 using adhesive film. The two opposing sides 1410 may also include holes 1401, 1402, and 1403. Accordingly, the printed circuit boards 1300 may be affixed to the sides 1410 using screws, rivets or other means to affix holes 1301 and 1401, 1302 and 1402, and 1303 and 1403.

Depending upon the dimensions of the modified box structure 1400 and the location of the slots 900, it is found sometimes to be desirable to use negative angles α such that the angled slots 900, and the linear regions 1305, 1306 and 1307 are parallel and substantially form the shape of a right-side-up, flattened “V”.

In the exemplary embodiment illustrated in FIG. 14A, two printed circuit boards 1300 are affixed to the opposing sides 1410 of the box structure 1400. As one of ordinary skill in the art would recognize, a similar result may be obtained by replacing all or part of the conductive sides 1410 of the box structure 1400 with the printed circuit boards 1300 having the openings 900 formed in a conductive layer on the same or opposite face to the features 1305, 1306 and 1307. Separately etching the printed circuit boards 1300, however, provides the benefit of increased flexibility. In the event that the boxed configuration is re-configured to emit radio frequency signals on different frequency band, the printed circuit boards 1300 may be replaced with different printed circuit boards optimized for operation at the new frequency band. Separately etching the printed circuit boards 1300 also provides the benefit of greater control of the manufacturing tolerances. This increased control is particularly useful when the non-conductive areas and conductive parasitic elements are located close together.

In a further embodiment shown in FIG. 13D there are formed in the outer area of the conductively clad face 1320 of the printed circuit board 1300, not only the two angled linear conductive regions 1305 and 1307, but an outer conductive region 1321 having within it an angled non-conductive slot 1322. As shown in FIG. 13D, the non-conductive areas 1306 and 1322 and the conductive parasitic elements 1305 and 1307 may be etched on the printed circuit boards 1300 or directly on the side of box structure 1400 provided the sides of the box structure 1400 include both a conductive layer and an insulating layer similar to the printed circuit board 1300.

The dimensions of the angled outer parasitic element 1305 together with those of the non-conductive areas 1322 of the printed circuit board 1300 and/or the angled openings 900 of the box 1400 may be optimised for operation over a first extended frequency range (for example, the outer parasitic element may be approximately one half-wavelength long at selected frequencies in the 1710-2170 MHz range). The dimensions of the conductive parasitic element 1307 and the inner angled non-conductive area 1306 may optimized for operation at a second extended frequency range (for example, approximately one half wavelength long at selected frequencies in the 2170-2600 MHz range). The widths of each respective parasitic element and non-conductive area may be chosen to optimise their coupling to the electromagnetic field radiated by the crossed dipole element 102 and the mutual coupling between each nested conductive element and slot. Further additional conductive parasitic elements may be positioned within each of the non-conductive areas. The inner conductive area 1307 may include an additional non-conductive parasitic slot which in turn may also include an additional conductive parasitic element disposed within the con-conductive area. The only limit to the number of nested conductive parasitic elements and non-conductive areas is the space available within each non-conductive area for an additional conductive parasitic element. The lengths of the additional conductive parasitic elements and the non-conductive areas within the additional conductive parasitic elements may be configured to further control the azimuth beamwidth of the radiating elements proximate to the conductive parasitic elements.

FIG. 14B is a chart illustrating the radiation pattern generated by the boxed configuration of 1400 of FIG. 14A across a frequency range of 1700-2200 MHz. The dotted line illustrates the 3-dB azimuth beamwidth of one exemplary embodiment in which the printed circuit boards 1300 are affixed to the sides 1410 of the boxed configuration of 1400 at a distance (S) of 48 mm from the center of the crossed dipole radiator 102. The solid line illustrates the 3-dB azimuth beamwidth of another exemplary embodiment in which in which the printed circuit boards 1300 are affixed to the sides 1410 of the boxed configuration of 1400 at a distance (S) of 104 mm from the center of the crossed dipole radiator 102. As FIG. 14B illustrates, the boxed configuration 1400 provides near-constant azimuth beamwidth and small beamwidth dispersion over a wide bandwidth. For S=48 mm, the beamwidth has a mean value of 78 degrees with a variation of +/−2 degrees over the 1700-2200 MHz frequency range. For S=104 mm, the beamwidth has a mean value of 59.5 degrees with a variation of +/−2 degrees over the same frequency range.

Arrays with Laterally Disposed High-Band and Low-Band Radiating Elements

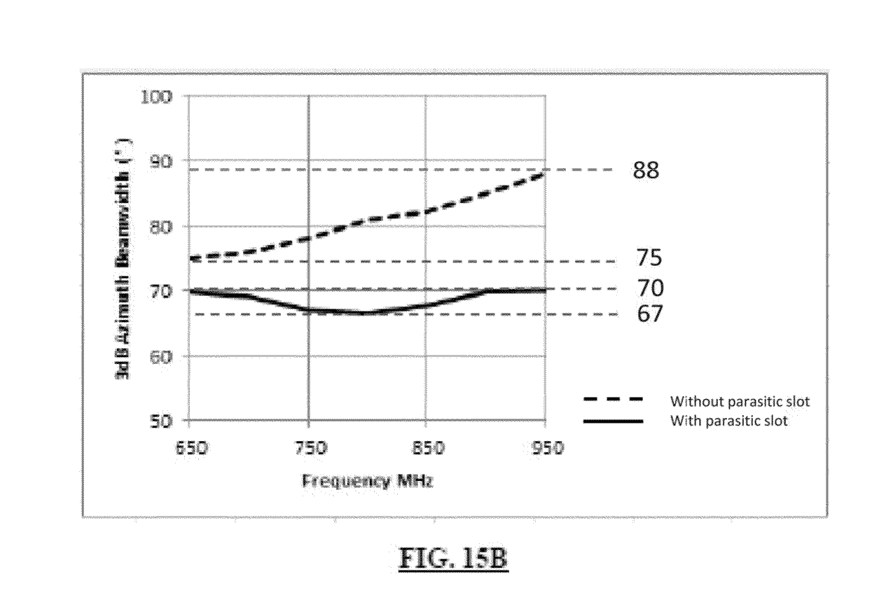

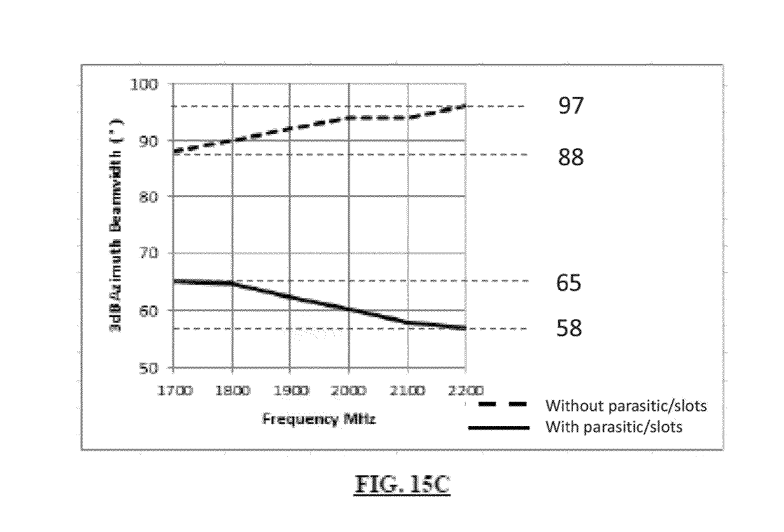

FIG. 15A is a top view illustrating an antenna array 1500 according to another exemplary embodiment. Antenna array 1500 includes one or more radiating elements each configured to operate within a first frequency range and one or more radiating elements configured to operate in a second frequency range. The first and second frequency ranges may be non-contiguous. For example, antenna array 1500 includes a first array of crossed dipole radiators 102 operating in a high frequency range (for example, 1710-2700 MHz), each radiator being aligned substantially on a common vertical axis in the direction of maximum azimuth radiation. The antenna array 1500 also includes a second vertical array of crossed dipole radiators operating in a low frequency range (for example, 698-960 MHz) 1502. The array of crossed dipole radiators 1502 may be aligned with the array of crossed dipole radiators 102 such that the two arrays have a common direction of maximum radiation. Such dual column, laterally spaced arrays may include vertical columns of eight or more high-frequency elements and four or more low frequency elements.

According to exemplary embodiments, parasitic strips 1511 are disposed symmetrically on opposing sides of each of the crossed dipole radiators 102. Each of the parasitic strips 1511 include slots 1512. Parasitic strips 1521 are disposed on opposing sides of each of the crossed dipole radiators 1502. Each of the parasitic strips 1521 include slots 1522.

For example, the antenna array 1500 illustrated in FIG. 15A includes one column of parasitic strips 1511 including slots 1512, one column of crossed dipole radiators 102, one column of parasitic strips 1511 including slots 1512, one column which includes crossed dipole radiator 1502 and one column which includes parasitic strip 1521 and slot 1522. The array of dipoles 102 has an operating frequency which is approximately double that of the array of dipoles 1502, so the vertical spacing between the dipoles 102 is chosen to be exactly one half of that between the dipoles 1503. A line which intersects the midpoints of both the crossed dipole radiator 1502 and one of the crossed dipole radiators 102 intersects the midpoint of two parasitic strips 1521 and two parasitic strips 1511. This arrangement ensures that one of the parasitic strips 1511 can be nested within the slot 1522 of one of the parasitic strips 1521.

As described above, the parasitic strips 1511 are typically positioned a quarter wavelength at the higher operating frequency band from the crossed dipole radiators 102 while the parasitic strips 1521 are typically positioned a quarter wavelength at the lower operating frequency band from the crossed dipole radiators 1502. In one exemplary embodiment, the parasitic strips 1511 and 1521 are co-planar. This arrangement provides the benefit of ease of manufacture. In another exemplary embodiment, the parasitic strips 1511 and 1521 are in different planes. Each of the planes of the parasitic strips 1511 and 1521 may be chosen to provide the greatest beamwidth control in the relevant band. For example, the parasitic strip 1511 may be disposed at a distance of one quarter wavelength in front of the ground plane 104 at the mid-band frequency of crossed dipole radiators 102 and the parasitic strip 1521 may be disposed at a distance of one quarter wavelength in front of the ground plane 104 at the mid-band frequency of crossed dipole radiators 1502. The locations of the parasitic strips 1511 and 1521 relative to the crossed dipole radiators 102 and 1502, together with their chosen length, provide the most constant azimuth beamwidth across the desired operating frequency band. For example, he slotted parasitic strips 1511 and 1521 are preferably approximately λ_{L}/2 long in the vertical direction, wherein λ_{L} is the free-space wavelength at a first (lower) frequency over which beamwidth control is sought within each respective operating frequency band. Similarly, slots 1512 and 1522 are preferably approximately λ_{H} in the vertical direction, wherein λ_{H} is the free-space wavelength at a second (higher) frequency within each respective frequency band. For example, if the length of the slotted parasitic strips 1511 and slots 1512 are chosen to control beamwidth in the 1710-2170 MHz frequency band, they will be based on a wavelength λ_{L} of 175 mm (i.e. strip length=175/2 mm=87.5 mm) and a wavelength λ_{H} of 138 mm (i.e., slot length=138/2 mm=69 mm). Similarly, if the length of the slotted parasitic strips 1521 and slots 1522 are chosen to control beamwidth in the 698-960 MHz frequency band, they will be based on a wavelength λ_{L} of 430 mm (i.e. strip length=430/2 mm=215 mm) and a wavelength λ_{H} of 312 mm (i.e., slot length=312/2 mm=156 mm).

FIG. 15B is a chart illustrating the 3-dB beamwidth generated by the antenna array 1500 across a frequency range of 650-950 MHz according to exemplary embodiments. The dashed line illustrates the 3-dB azimuth beamwidth of crossed dipole radiators without parasitic strips while the solid line illustrates the 3-dB azimuth beamwidth of antenna array 1500, including parasitic strips 1521 with an exemplary strip length of 215 mm and slots 1522 with an exemplary slot length of 156 mm. As FIG. 15B illustrates, the parasitic strips 1511 and the slots 1512 reduce the beamwidth and beamwidth dispersion across the entire 650-950 MHz frequency range. Without the parasites the mid-band beamwidth was 80 degrees and dispersion was 88−75=13 degrees, with the parasites the mid-band beamwidth is 67 degrees and the dispersion is 70−67=3 degrees. FIG. 15C is a chart illustrating the 3-dB beamwidth generated by the antenna array 1500 across a frequency range of 1700-2200 MHz according to exemplary embodiments. The dashed line illustrates the 3-dB azimuth beamwidth of crossed dipole radiators without parasitic strips while the solid line illustrates the 3-dB azimuth beamwidth of antenna array 1500, including parasitic strips 1521 with an example strip length of 87.5 mm and slots 1522 with an example slot length of 69 mm. As FIG. 15B illustrates, the parasitic strips 1521 and the slots 1522 reduce the beamwidth and beamwidth dispersion across the entire 1700-2200 MHz frequency range. Without parasites the mid-band beamwidth was 93 degrees and the dispersion was 97−88=9 degrees, with the parasites the midband beamwidth is 62 degrees and the dispersion is 65−58 degrees=7 degrees. An additional parasitic strip may be disposed within the slots 1512 and 1522 and the additional parasitic strip may itself include a slot. The lengths of the additional parasitic strip and the slot within the additional parasitic strip may be configured to further control the azimuth beamwidth of the radiating elements proximate to the parasitic strip. Further additional parasitic strips, with or without slots, may be nested within each of the slots of the parasitic strips the slots 1512 and 1522. The only limit to the number of nested parasitic strips is the space available within each slot for an additional parasitic strip.

Although certain exemplary embodiments have been described herein, it will be apparent to those skilled in the art that variations and modifications of the various embodiments shown and described herein may be made without departing from the spirit and scope of the inventive concept. For example, although exemplary embodiments are described primarily with respect to operating in the 1700-3000 MHz frequency range, exemplary embodiments may also be realized in other frequency ranges with similar results through the use of scaling. Exemplary embodiments may also be realized with antenna configurations other than the slant-polar configurations described above. Furthermore, it will be appreciated by those skilled in the art that the principle of the use of a slot within a linear parasite and of a linear parasite within a slot may be extended to include multiple nested arrangements, enabling beamwidth control over further extended contiguous or non-contiguous frequency ranges. Accordingly, it is intended that the aforementioned disclosure be limited only to the extent required by the following claims and the applicable rules of law.

What is claimed is:

1. An antenna comprising:
a conductive ground plane;
a radiating element; and
two conductive parasitic elements laterally disposed on opposing sides of the radiating element, each of the conductive parasitic elements comprising an elongate conductive member and an elongate opening,
wherein the antenna is configured to radiate or receive a radio frequency signal with a substantially constant azimuth beamwidth over an extended frequency range.

2. The antenna of claim 1, wherein the radiating element comprises a crossed-dipole antenna comprising two orthogonal elongate conductive dipole elements oriented to radiate or receive signals with a linear polarisation inclined +45 degrees and −45 degrees from the vertical.

3. The antenna of claim 1, wherein the radiating element comprises a dual-polar patch element oriented to radiate or receive signals with a linear polarisation inclined +45 and −45 degrees from the vertical.

4. The antenna of claim 1, wherein at least one of the two conductive parasitic elements comprises:
a first elongate conductive member;
an elongate opening disposed within the first elongate conductive member; and
a second elongate conductive member disposed within the elongate opening.

5. The antenna of claim 4, wherein the second elongate conductive member comprises a second elongate opening disposed within the second elongate conductive member.

6. The antenna of claim 4, wherein the first elongate conductive member and the second elongate conductive member are substantially co-planar in a plane in front of the ground plane.

7. The antenna of claim 4, wherein the first elongate conductive member is disposed a first distance in front of the ground plane and the second elongate conductive member is disposed a second distance above the ground plane.

8. The antenna of claim 1, wherein the extended frequency range comprises two non-contiguous frequency ranges.

9. The antenna of claim 1, wherein the extended frequency range comprises a frequency range from 698 to 960 MHz.

10. The antenna of claim 1, wherein the extended frequency range comprises a frequency range from 1700 to 3000 MHz.

11. The antenna of claim 1, wherein the extended frequency range comprises frequencies from 698 to 960 MHz and from 1710 to 2700 MHz.

12. The antenna of claim 1, wherein the radiating element comprises a first radiating element configured to radiate or receive a first radio frequency signal with a substantially constant azimuth beamwidth over a first frequency range, and
a second radiating element configured to radiate or receive a second radio frequency signal with a substantially constant azimuth beamwidth over a second frequency range.

13. The antenna of claim 12, wherein the second radiating element is laterally disposed relative to the first radiating element and the first radiating element and the second radiating element have a common direction of maximum radiation.

14. The antenna of claim 12, wherein the first radiating element and the second radiating element are electrically connected to a common feed network.

15. An antenna comprising:
a conductive ground plane;
a radiating element disposed in front of the ground plane; and
a box structure comprising four conductive planes disposed around the radiating element,
wherein two of the four conductive planes each comprises an opening, each of the openings comprising a first elongate linear region and a second elongate linear region,
wherein the longitudinal axis of the first elongate linear region is vertically disposed at an angle greater than or equal to 20 degrees relative to the longitudinal axis of the second elongate linear region.

16. The antenna of claim 15, wherein each of the openings further comprises a third linear region,
wherein the first elongate linear region and the second elongate linear region are connected by the third linear region, and
wherein the third linear region is substantially parallel to the conductive ground plane.

17. The antenna of claim 15, wherein each opening comprises a first conductive parasitic member disposed within each opening.

18. The antenna of claim 17, wherein each of the first conductive parasitic members comprises a first elongate linear region and a second elongate linear region, wherein the first elongate linear region of the first conductive parasitic member is disposed substantially parallel to the first elongate linear region of the opening and the second linear region of the first conductive parasitic member is disposed substantially parallel to the second elongate linear region of the opening.

19. The antenna of claim 17, wherein each of the first conductive parasitic members comprises a non-conductive area disposed within each of the first conductive parasitic members.

20. The antenna of claim 19, wherein each of the non-conductive areas comprises a first elongate linear region and a second elongate linear region, wherein the first elongate linear region of the non-conductive area is disposed substantially parallel to the first elongate linear region of the first conductive parasitic element and the second elongate linear region of the non-conductive area is disposed substantially parallel to the second elongate linear region of the first conductive parasitic element.

21. The antenna of claim 20, wherein each non-conductive area comprises a second conductive parasitic member disposed within each non-conductive area.

22. The antenna of claim 21, wherein each of the second conductive parasitic members comprises a first elongate linear region and a second elongate linear region, wherein the first elongate linear region of the second conductive parasitic member is disposed substantially parallel to the first elongate linear region of the non-conductive area and second elongate linear region of the second conductive parasitic member is disposed substantially parallel to the second elongate linear region of the non-conductive area.

23. The antenna of claim 15, wherein the radiating element comprises a crossed-dipole antenna comprising two orthogonal elongate conductive dipole elements oriented to radiate or receive signals with a linear polarisation inclined +45 degrees and −45 degrees from the vertical.

24. The antenna of claim 15, wherein the radiating element comprises a dual-polar patch element oriented to radiate or receive signals with a linear polarisation inclined +45 and −45 degrees from the vertical.

25. The antenna of claim 15, wherein the antenna is configured to transmit or receive a radio frequency signal with a substantially constant azimuth beamwidth over an extended frequency range.

26. The antenna of claim 15, wherein the antenna is configured to radiate or receive a radio frequency signal with a substantially constant azimuth beamwidth, a high rate of roll-off, and a large front-to-back ratio over an extended frequency range.

27. The antenna of claim 15, wherein the radiating element comprises a first radiating element configured to radiate or receive a first radio frequency signal with a substantially constant azimuth beamwidth over a first frequency range, and
a second radiating element configured to radiate or receive a second radio frequency signal with a substantially constant azimuth beamwidth over a second frequency range.

28. The antenna of claim 27, wherein the second radiating element is laterally disposed relative to the first radiating element and the first radiating element and the second radiating element have a common direction of maximum radiation

29. The antenna of claim 27, wherein the first radiating element and the second radiating element are electrically connected to a common feed network.

30. An antenna, comprising:
a ground plane;
a first radiating element configured to radiate or receive a first radio frequency signal over a first frequency range;
a second radiating element configured to radiate or receive a second radio frequency signal over a second frequency range; and
a first elongate conductive parasitic member comprising a first elongate opening, laterally disposed relative to the first radiating element,
wherein the first elongate conductive parasitic member and the first elongate opening are configured to reduce an azimuth beamwidth and a variation of the azimuth beamwidth of the first radio frequency signal over the first frequency range.

31. The antenna of claim 30, further comprising:
a second elongate conductive parasitic member comprising a second elongate opening, laterally disposed relative to the second radiating element,
wherein the second elongate conductive parasitic member and the second elongate opening are configured to reduce an azimuth beamwidth and a variation of the azimuth beamwidth of the second radio frequency signal over the second frequency range.

32. The antenna of claim 30, further comprising:
a third elongate conductive parasitic member comprising a third elongate opening, laterally disposed between the first radiating element and the second radiating element; and
a fourth elongate conductive parasitic member disposed within third elongate opening,
wherein the third elongate conductive parasitic element, the third elongate opening, and the fourth elongate conductive parasitic element are configured to reduce the azimuth beamwidth and the variation of the azimuth beamwidth of both the first and the second radio frequency signals.

33. The antenna of claim 32, wherein the fourth elongate conductive parasitic member comprises a fourth elongate opening.

34. The antenna of claim 32, wherein the third elongate conductive parasitic member and the fourth elongate conductive member are substantially co-planar in a plane in front of the ground plane.

35. The antenna of claim 32, wherein the third elongate conductive parasitic member is disposed a first distance in front of the ground plane and the fourth elongate conductive parasitic member is disposed a second distance above the ground plane.
